(19) United States
(12) Patent Application Publication
(10) Pub. No.: US 2019/0171064 A1
(43) Pub. Date: Jun. 6, 2019

(54) SOFT ADDITIVE IMAGE MODALITY FOR MULTI-LAYER DISPLAY

(71) Applicant: Pure Depth, Inc., Redwood City, CA (US)

(72) Inventors: John D. NEWTON, Auckland (NZ); Jamie P. HEATHER, Auckland (NZ); Yao SHUYUN, Auckland (NZ); Austin F. O'BRIEN, Auckland (NZ); Richard N. MANS, Ngaruawahia (NZ)

(21) Appl. No.: 16/195,881

(22) Filed: Nov. 20, 2018

Related U.S. Application Data
(60) Provisional application No. 62/589,608, filed on Nov. 22, 2017.

(51) Int. Cl. G02F 1/1335; H04N 13/395; G09G 3/36; G06F 3/0488; G06F 3/0484; G02F 1/1333; G06F 3/041

(52) U.S. Cl. CPC G02F 1/133602; H04N 13/395; G09G 3/36; G06F 3/0412; G06F 3/04842; G02F 1/13338; G06F 3/0488

(57) ABSTRACT

A multi-layer display system may include a plurality of display panels arranged in an overlapping manner, a backlight configured to provide light to the plurality of display screens, and a processing system. Each of the display panels include a plurality of multi-domain liquid crystal display cells. The processing system may be configured to display a first object on the front display panel of the plurality of display panels, display, on a display panel overlapped by the front display, a second object such that the second object is at least partially overlapped by the first object. The first and second objects are displayed according to a soft additive model, where the superposition of bright colors results in a brighter color.

### CROSS REFERENCE TO RELATED APPLICATION

This patent application claims priority to and the benefit of U.S. Provisional Application No. 62/589,608, filed on Nov. 22, 2017, which is hereby incorporated herein by reference in its entirety.

### FIELD OF THE INVENTION

The invention relates generally to multi-layer displays and, more particularly, to multi-layer displays and methods for displaying content on vehicle dash systems including a multi-layer displays.

### BACKGROUND

Image displays limited to a single two dimensional display lack depth information. To relay depth information of the objects there have been efforts to provide displays that can display the objects in three-dimensions. For example, stereo displays convey depth information by displaying offset images that are displayed separately to the left and right eye. However, stereo displays are limited from what angle the images can be viewed.

Multi-layer displays have been developed to display objects with a realistic perception of depth due to displacement of stacked displays screens. However, conventional graphics created for traditional displays cannot always be properly displayed on such displays. For example, challenges are encountered due to blending of the images when different content is simultaneously displayed on different displays of the multi-layer display.

### SUMMARY

Exemplary embodiments of this disclosure provide a display system that can display content on different display screens of a multi-layer display provided in a stacked arrangement. The multi-layer display system may include a plurality of display panels arranged in an overlapping manner, a backlight configured to provide light to the plurality of display screens, and a processing system. Each of the display panels include a plurality of multi-domain liquid crystal display cells. The processing system may be configured to display a first object on the front display panel of the plurality of display panels, display, on a display panel overlapped by the front display, a second object such that the second object is at least partially overlapped by the first object.

According to one exemplary embodiment, an instrument panel comprises a multi-layer display system including a front display panel and a rear display panel arranged in a substantially parallel manner, the front display panel overlapping the rear display panel, the front display panel and the rear display panel each including a plurality of multi-domain liquid crystal display cells; a backlight configured to provide light to the front display panel and the rear display panel of the multi-layer display system; and a processing system comprising at least one processor and memory. The processing system is configured to display a first object on the front display panel; and display, on the rear display panel, a second object such that the second object is at least partially overlapped by the first object.

In another exemplary embodiment, the front display panel and the rear display panel are multi-domain in-plane-switching liquid crystal displays.

In another exemplary embodiment, the front display panel and the rear display panel are triple-domain in-plane-switching liquid crystal displays.

In another exemplary embodiment, the first object is displayed such that at least a portion of the first object overlaps the second object displayed on the rear display panel, and at least a portion of the first object is displayed without overlapping the second object.

In another exemplary embodiment, relative luminance of the first object displayed on the front display panel is higher than relative luminance of the second object displayed on the rear display panel.

In another exemplary embodiment, the first object if of a uniform color that is different from a uniform color of the second object.

In another exemplary embodiment, the first object is displayed in a manner to maintain appearance of being solid and in front of the second object displayed on the rear display panel.

In another exemplary embodiment, the first object has a same shape and size as the second object, and the first and second objects are displayed in an overlapping manner

In another exemplary embodiment, the first object has a same shape and size as the second object, and the first and second objects are displayed in an overlapping manner

In another exemplary embodiment, the front display panel is a touch sensitive display, and the processing system is configured to detect whether a touch input is performed to a portion of the front display displaying the first object.

In another exemplary embodiment, the first object is displayed in a manner on the front display to maintain appearance of being solid and in front of the second object displayed on the rear display panel.

In another exemplary embodiment, the plurality of multi-domain liquid crystal display cells in the front display and rear display include a liquid crystal material disposed between a first substrate and a second substrate to form a liquid crystal cell, and a chevron shaped electrode structure including a plurality of chevron-shaped cell electrodes interleaved with a plurality of chevron-shaped common electrodes in the first substrate, wherein the interleaved plural chevron-shaped cell and common electrodes divide the cell into a plurality of regions.

In another exemplary embodiment, a multi-layer display system, comprises: a first display and a second display arranged in a substantially parallel manner to the first display, the first display overlapping the second display, and the first display and the second display each including a plurality of multi-domain liquid crystal display cells; a light source configured to provide light to the first display and the second display; and a processing system comprising at least one processor and memory. The processing system is configured to: display a first object on the first display; and display, on the second display, a second object such that the second object is at least partially overlapped by the first object.

In another exemplary embodiment, relative luminance of the first object displayed on the first display is higher than relative luminance of the second object displayed on the second display.

In another exemplary embodiment, the processing system is further configured to: in response to instructions to move the second object displayed on the second display to the first display, display the second object with a relative luminance that is higher than the relative luminance used to display the second object on the first display.

In another exemplary embodiment, the second object displayed on the first display at least partially overlaps content displayed on the first display.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

So that features of the present invention can be understood, a number of drawings are described below. It is to be noted, however, that the appended drawings illustrate only particular embodiments of the invention and are therefore not to be considered limiting of its scope, for the invention may encompass other equally effective embodiments.

FIG. 1 illustrates a multi-layer display system according to an embodiment of the present disclosure.

FIGS. 2A-2F illustrate an in-plane switching mode liquid crystal display device (IPS-LCD) cell in different operating states (e.g., an off state and an on state).

FIGS. 3A and 3B illustrate basic model RGB transmittance vs cumulative director angle of two overlaid display panels.

FIG. 4 illustrates an example application of the basic display model on a multi-layer display system.

FIG. 5 illustrates exemplary operation of a multi-domain liquid crystal display cell.

FIGS. 6A and 6B illustrate exemplary simulations of director distributions at different locations of a liquid crystal cell.

FIGS. 7A-7B and 8A-8B illustrate exemplary simulation results of comparing triple domain IPS (In-Plane Switching) and single domain TN (Twisted Nematic) panels.

FIGS. 9A-9B illustrate exemplary simulations of MLD displays using gray-on-gray examples.

FIGS. 10A-10B illustrate exemplary simulations of MLD displays using gray-on-gray examples.

FIGS. 11A-11B illustrate exemplary simulations of MLD displays using gray-on-gray examples.

FIGS. 12A-12B illustrate exemplary simulations of MLD displays using gray-on-gray examples.

FIGS. 13A-13B illustrate exemplary simulations of MLD displays using gray-on-gray examples.

FIGS. 14A-14B illustrate exemplary simulations of MLD displays using gray-on-gray examples.

FIGS. 15A-15B illustrate exemplary simulations of MLD displays using gray-on-gray examples.

FIGS. 16A-16B illustrate exemplary simulations of MLD displays using color-on-color examples.

FIGS. 16A-16B illustrate exemplary simulations of MLD displays using color-on-color examples.

FIGS. 17A-17B illustrate exemplary simulations of MLD displays using color-on-color examples.

FIGS. 18A-18B illustrate exemplary simulations of MLD displays using color-on-color examples.

FIGS. 19A-19B illustrate exemplary simulations of MLD displays using color-on-color examples.

FIGS. 20A-20B illustrate exemplary simulations of MLD displays using color-on-color examples.

FIGS. 21A-21B illustrate exemplary simulations of MLD displays using color-on-color examples.

FIGS. 22A-22B illustrate exemplary simulations of MLD displays using color-on-color examples.

FIGS. 23A-23B illustrate exemplary simulations of MLD displays using color-on-color examples.

FIGS. 24A-24B illustrate exemplary simulations of MLD displays using color-on-color examples.

FIGS. 25A-25B illustrate exemplary simulations of MLD displays using color-on-color examples.

FIGS. 26A-26B illustrate exemplary validation results between simulation of a single domain (TN) model and a MLD including TN panels.

FIGS. 27A-27B illustrate exemplary validation results between simulation of a single domain (TN) model and a MLD including TN panels.

FIGS. 28A-28B illustrate exemplary validation results between simulation of a single domain (TN) model and a MLD including TN panels.

FIGS. 29A-29B illustrate exemplary validation results between simulation of a single domain (TN) model and a MLD including TN panels.

FIGS. 30A-30B illustrate exemplary validation results between simulation of a single domain (TN) model and a MLD including TN panels.

FIGS. 31A-31B illustrate exemplary validation results between simulation of a single domain (TN) model and a MLD including TN panels.

FIGS. 32A-32B illustrate exemplary validation results between simulation of a single domain (TN) model and a MLD including TN panels.

FIGS. 33A-33B illustrate exemplary validation results between simulation of a single domain (TN) model and a MLD including TN panels.

FIGS. 34A and 34B illustrate exemplary images that are displayed on rear panel and the front panel.

FIG. 34C illustrate a simulation of FIGS. 34A and 34B content displayed on a MLD and viewed at intended viewing angle.

FIGS. 35A-35B illustrate an exemplary simulation of FIGS. 34A and 34B content displayed on a MLD and viewed slightly off-axis from the intended viewing angle for the triple domain (IPS) model and the single domain (TN) model.

FIGS. 36A-36B illustrate exemplary simulations of content displayed on a triple domain (IPS) MLD and single domain (TN) MLD and viewed slightly off-axis from the intended viewing angle.

FIGS. 37A-37B illustrate exemplary simulations of content displayed on a triple domain (IPS) MLD and single domain (TN) MLD and viewed slightly off-axis from the intended viewing angle.

FIGS. 38A-38B illustrate exemplary simulations of content displayed on a triple domain (IPS) MLD and single domain (TN) MLD and viewed slightly off-axis from the intended viewing angle.

FIGS. 39A-39B illustrate exemplary simulations of content displayed on a triple domain (IPS) MLD and single domain (TN) MLD and viewed slightly off-axis from the intended viewing angle.

FIGS. 40A-40B illustrate exemplary simulations of content displayed on a triple domain (IPS) MLD and single domain (TN) MLD and viewed slightly off-axis from the intended viewing angle.

FIGS. 41A-41B illustrate exemplary simulations of content displayed on a triple domain (IPS) MLD and single domain (TN) MLD and viewed slightly off-axis from the intended viewing angle.

FIGS. 42A-42B illustrate exemplary simulations of content displayed on a triple domain (IPS) MLD and single domain (TN) MLD and viewed slightly off-axis from the intended viewing angle.

FIGS. 43A-43B illustrate exemplary simulations of content displayed on a triple domain (IPS) MLD and single domain (TN) MLD and viewed slightly off-axis from the intended viewing angle.

FIGS. 44A-44B illustrate exemplary simulations of content displayed on a triple domain (IPS) MLD and single domain (TN) MLD and viewed slightly off-axis from the intended viewing angle.

FIGS. 45A-45B illustrate exemplary simulations of content displayed on a triple domain (IPS) MLD and single domain (TN) MLD and viewed slightly off-axis from the intended viewing angle.

FIG. 46 illustrates an exemplary processing system upon which various embodiments of the present disclosure(s) may be implemented.

### DETAILED DESCRIPTION

Multi-layer displays have two display screens in a stacked arrangement to provide real depth between images displayed on the first display screen and images displayed on the second display screen. When content is simultaneously displayed on each display of the multi-layer display, content displayed on one display can change the way content displayed on another panel is seen because the panels are stacked. This is particularly true when the content in one at least partially overlaps content in another panel. To ovoid these issue, conventional approaches display content on different displays without overlapping the content on one screen with content on another screen.

Embodiments of this disclosure provide for using a multi-layer display system including a plurality of display panels, with each display panel including a plurality of multi-domain liquid crystal display cells. Content (e.g., graphics, texts etc.) is displayed on each of the panels simultaneously with at least a portion of the content displayed one panel overlapping content displayed on another panel. As explained in this disclosure, there are advantages in using multi-domain liquid crystal display cells to simultaneously display overlapping content on multiple displays of the multi-layer display. These advantages are not only evident when the content is viewed from the intended viewing angle but are also observed when the content is viewed slightly off-axis from the intended viewing angle.

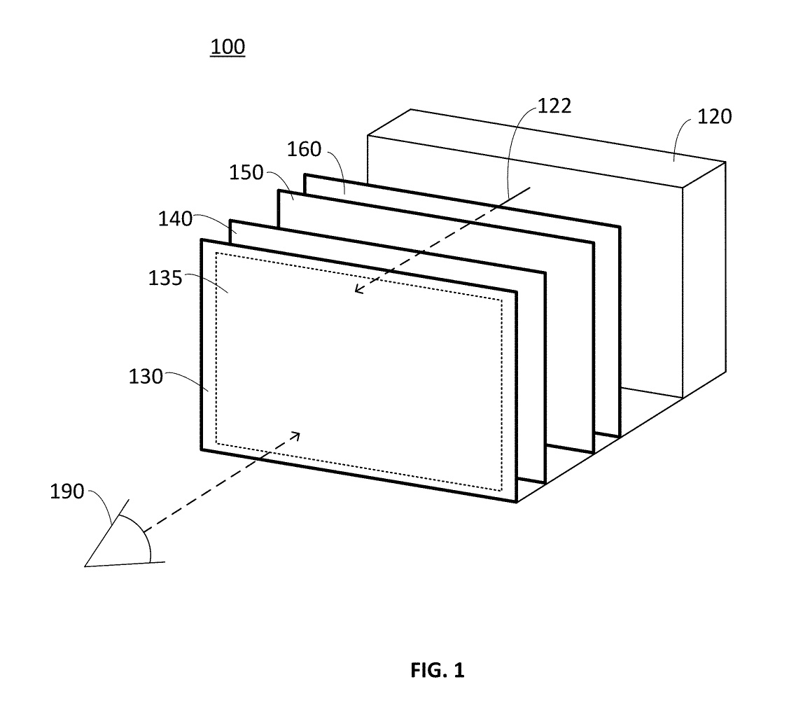

FIG. 1 illustrates a multi-layer display system 100 according to an embodiment of the present disclosure. The display system 100 may include a light source 120 (e.g., rear mounted light source, side mounted light source, optionally with a light guide), and a plurality of display screens 130-160. Each of the display screens 130-160e may include multi-domain liquid crystal display cells.

The display screens 130-160 may be disposed substantially parallel or parallel to each other and/or a surface (e.g., light guide) of the light source 120 in an overlapping manner In one embodiment, the light source 120 and the display screens 130-160 may be disposed in a common housing. The display apparatus 100 may be provided in an instrument panel installed in a dashboard of a vehicle. The instrument panel may be configured to display information to an occupant of the vehicle via one or more displays 130-160 and/or one or more mechanical indicators provided in the instrument panel. The displayed information may include vehicle speed, engine coolant temperature, oil pressure, fuel level, charge level, and navigation information, but is not so limited. It should be appreciated that the elements illustrated in the figures are not drawn to scale, and thus, may comprise different shapes, sizes, etc. in other embodiments.

The display system 100 may be configured to display a first object on one display (e.g., a front display panel) and display a second object on another display (e.g., a rear display panel). The first object may at least partially overall the second object as viewed by an observer looking towards the rear display panel via the front display panel. The first and second objects may be displayed according to a soft additive model, where the superposition of bright colors results in a brighter color.

The light source 120 may be configured to provide illumination for the display system 100. The light source 120 may provide substantially collimated light 122 that is transmitted through the display screens 130-160.

Optionally, the light source 120 may provide highly collimated light using high brightness LED's that provide for a near point source. The LED point sources may include pre-collimating optics providing a sharply defined and/or evenly illuminated reflection from their emission areas. The light source 120 may include reflective collimated surfaces such as parabolic mirrors and/or parabolic concentrators. In one embodiment, the light source 120 may include refractive surfaces such as convex lenses in front of the point source. However, the LEDs may be edge mounted and direct light through a light guide which in turn directs the light toward the display panels in certain example embodiments.

Each of the display panels/screens 130-160 may include a liquid crystal display (LCD) matrix, which a backplane that may be glass or polymer. Alternatively, the display screens 130-160 may include organic light emitting diode (OLED) displays, transparent light emitting diode (TOLED) displays, cathode ray tube (CRT) displays, field emission displays (FEDs), field sequential display or projection displays. In one embodiment, the display panels 130-160 may be combinations of either full color RGB, RGBW or monochrome panels. The display screens 130-160 are not limited to the listed display technologies and may include other display technologies that allows for the projection of light. In one embodiment, the light may be provided by a projection type system including a light source and one or more lenses and/or a transmissive or reflective LCD matrix. The display screens 130-160 may include a multi-layer display unit including multiple stacked or overlapped display layers each configured to render display elements thereon for viewing through the uppermost display layer.

In one embodiment, each of the display screens 130-160 may be approximately the same size and have a planar surface that is parallel or substantially parallel to one another. In another embodiment, one or more of the display screens 130-160 may have a curved surface. In one embodiment, one or more of the display screens 130-160 may be displaced from the other display screens such that a portion of the display screen is not overlapped and/or is not overlapping another display screen.

Each of the display screens 130-160 may be displaced an equal distance from each other in example embodiments. In another embodiment, the display screens 130-160 may be provided at different distances from each other. For example, a second display screen 140 may be displaced from the first display screen 130 a first distance, and a third display screen 150 may be displaced from the second display screen 140 a second distance that is greater than the first distance. The fourth display screen 160 may be displaced from the third display screen 150 a third distance that is equal to the first distance, equal to the second distance, or different from the first and second distances.

The display screens 130-160 may be configured to display graphical information for viewing by the observer 190. The viewer/observer 190 may be, for example, a human operator or passenger of a vehicle, or an electrical and/or mechanical optical reception device (e.g., a still image, a moving-image camera, etc.). Graphical information may include visual display of objects and/or texts with object and/or texts in one display screen overlapping objects and/or texts displayed on another display screen. In one embodiment, the graphical information may include displaying images or a sequence of images to provide video or animations. In one embodiment, displaying the graphical information may include moving objects and/or text across the screen or changing or providing animations to the objects and/or text. The animations may include changing the color, shape and/or size of the objects or text. In one embodiment, displayed objects and/or text may be moved between the display screens 130-160. The distances between the display screens 130-160 may be set to obtain a desired depth perception between features displayed on the display screens 130-160.

In displaying overlapping content on different screens, a color model applied to content displayed on a front display screen that overlaps content on a rear display screen may be applied a color model that is different to content on the front display screen that does not overlap other content on the rear display screen. Alternatively or in addition, a color model applied to content displayed on a rear display screen that is overlapped by content on a front display screen may be applied a color model that is different to content on the rear display screen that is not overlapped by content on the front display screen. In some embodiments, the user may move content on one of the display screens and the color model applied to the content may change based on whether the content overlaps and/or is overlapped by content on one or more other display screens as it is moved across the screen. In some examples, content displayed on a front display screen that overlaps content on a back display may be displayed with colors that are brighter than the colors that are used for overlapped content on a back display screen. A color model applied to content may change as content is moved (e.g., in response to a predetermined condition such as a user input) from one display screen to another display screen.

In some embodiments, content that is not overlapping and/or is not overlapped by content displayed on another display screen may be applied a color model that is different from content that is at least partially overlapping and/or is at least partially overlapped by content displayed on another display screen. A first color model may correspond to color values that are set in a different manner from a second color model. Relative luminance of content displayed according to one model may be different from content displayed based on another model. In some examples, one model may use a classical additive model which weights each layer equally, whereas another model may use a soft additive effect having the ability to seemingly ‘dilute’ the influence of back layers by running brighter colors on a display screen overlapping other display screen.

In one embodiment, a position of one or more of the display screens 130-160 may be adjustable by an observer 190 in response to an input. Thus, an observer 190 may be able to adjust the three dimension depth of the displayed objects due to the displacement of the display screens 130-160. A processing system may be configured to adjust the displayed graphics and gradients associated with the graphics in accordance with the adjustment.

Each of the display screens 130-160 may be configured to receive data and display, based on the data, a different image on each of the display screens 130-160 simultaneously. Because the images are separated by a physical separation due to the separation of the display screens 130-160, each image is provided at a different focal plane and depth is perceived by the observer 190 in the displayed images. The images may include graphics in different portions of the respective display screen.

While not illustrated in FIG. 1, the display system 100 may include one or more projection screens, one or more diffraction elements, and/or one or more filters between an observer 190 and the projection screen 160, between any two display screens 130-160, and/or the display screen 130 and the light source 120.

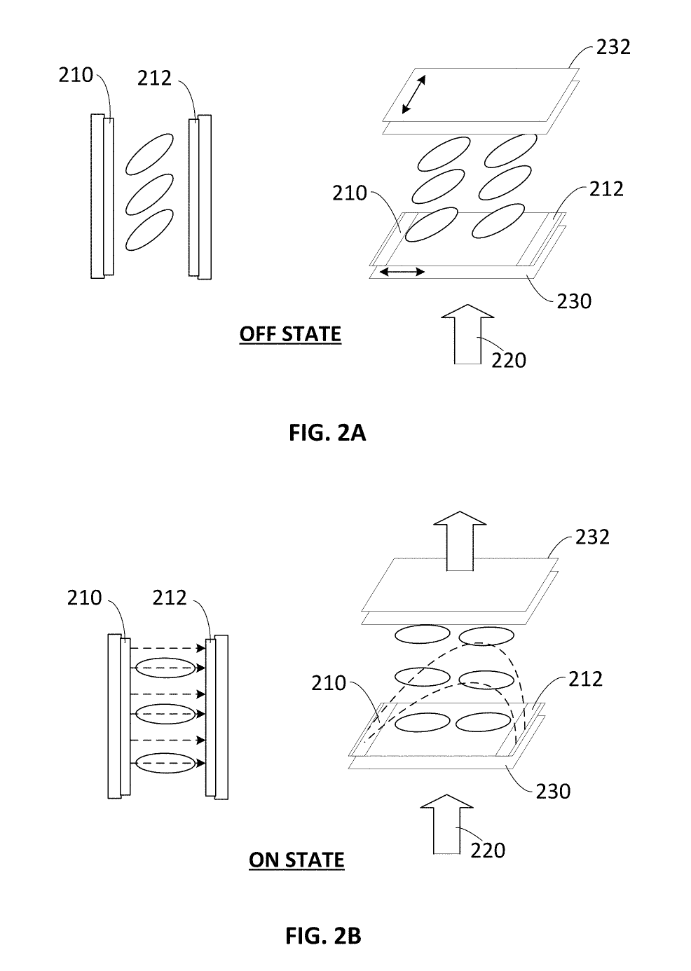

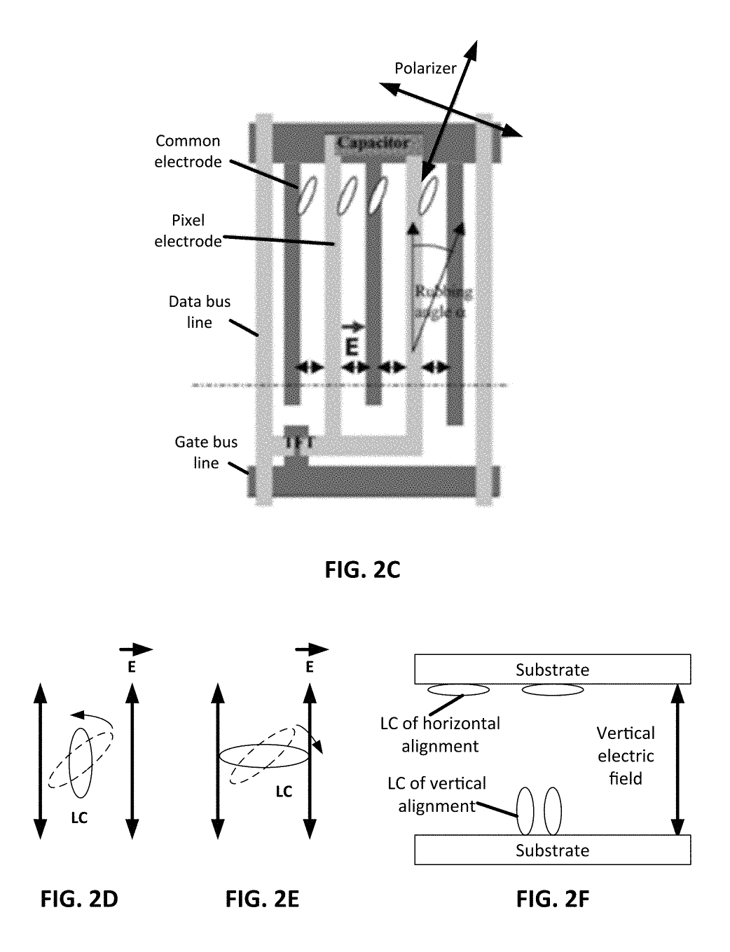

One or more of the display screens 130-160 may be in-plane switching mode liquid crystal display devices (IPS-LCDs). The IPS-LCD may be a crossed polarizer type with a polarizer on one side of the cells being perpendicular to a polarizer on an opposite side of the cells (i.e., transmission directions of the polarizers are placed at right angles). FIG. 2A illustrates top view and FIG. 2B illustrates a perspective view of an IPS-LCD cell in an off state and an on state. Typically in the off state, without a voltage applied to electrodes 210 and 212 liquid crystal molecules in the cell have a uniform orientation at typically about 10 degrees with the electrodes (the LC director is uniform throughout the cell).

The figures show the crossed polarizers at ˜10 degrees to vertical or horizontal. Normally the electrodes and alignment layer would be tilted. See pixel structure of an IPS display shown in FIG. 2C, which is provided at www.researchgate.net/figure/3453822_fig3_Fig-3-Schematic-pixel-structure-of-the-IPS-mode, incorporated herein by reference. Polarized light 220 enters and exits the cell without a change in the polarization. The polarized light 220 will be blocked in the off state, if a polarizer 230 on one side of the cell is provided perpendicular to a polarizer 232 on an opposite side of the cell.

FIGS. 2D and 2E show the movement of LC driven by electric field for the cases of positive LC (shown in FIG. 2D) and negative LC (shown in FIG. 2E). Dotted ellipses represent initial LC alignment. In FIG. 2F, notations of direction are represented with respect to the substrates.

In the on state, a voltage is applied to the electrodes 210 and 212. The electric field drives the liquid crystal molecules to rotate in the plane of the substrate towards the +/−10 degree pre-aligned electrodes with a preferred direction either clockwise or anti-clockwise and orient along the field direction. The rotation of the molecules causes a phase change to the polarized light 220. The light 220 will be transmitted in the on state.

The transmission T of the light 220, in the on state of an IPS-LCD, can be described by:

$$T = {sin}^{2} ( 2 θ ( V ) ) * {sin}^{2} ( π \frac{Δ nd}{λ} ) ,$$

where θ (V) is the angle between polarizer and the LC director, and is a function of the applied voltage; Δn is the birefringence of cell, d is the cell gap, and λ is the wavelength. Δnd can be chosen so that the value is ˜0.3, hence the second term in the equation can be maximized for visible wavelengths. At V=0, the LC director is parallel to the polarizer, θ=0°, hence T=0. At high voltage, most of the molecules align along the electric field, θ=45°, hence T=1.

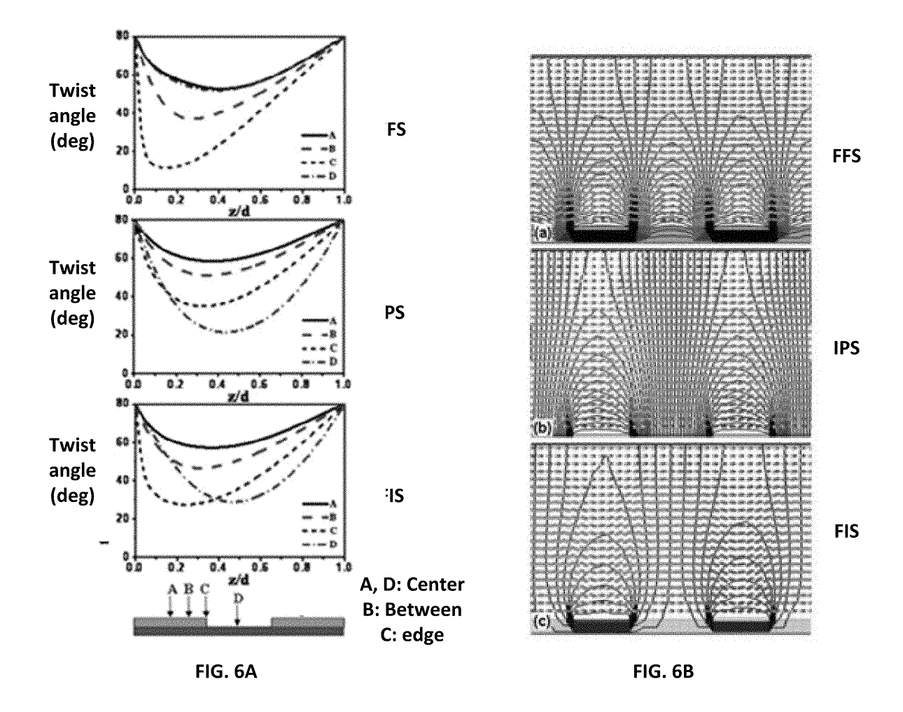

The electric field Ey is always about 80 degrees to LC photo alignment layer=LC molecules at rest. FIG. 5 shows this as Ey. This gives a torque to the LC molecules balancing the bulk liquid crystal torque causing some of the LC to twist. The LC direction at the boundary alignment layer which is locked parallel to the layer supplies this restoring torque. The electrodes and alignment layers direction can either be horizontal or vertical. The alignment layer may be on both of the TFT and CF sides. The bulk of the twist is in the center of the LC volume as seen in FIG. 6A.

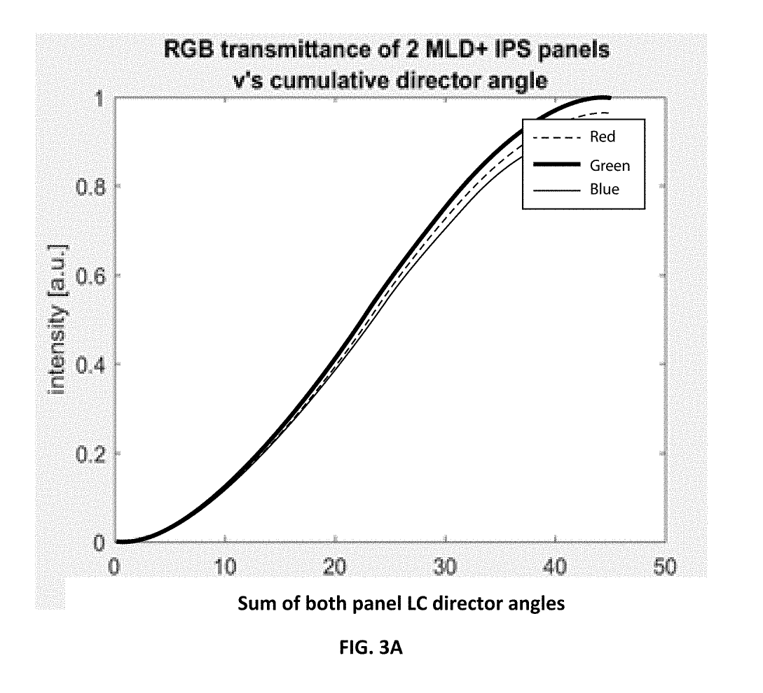

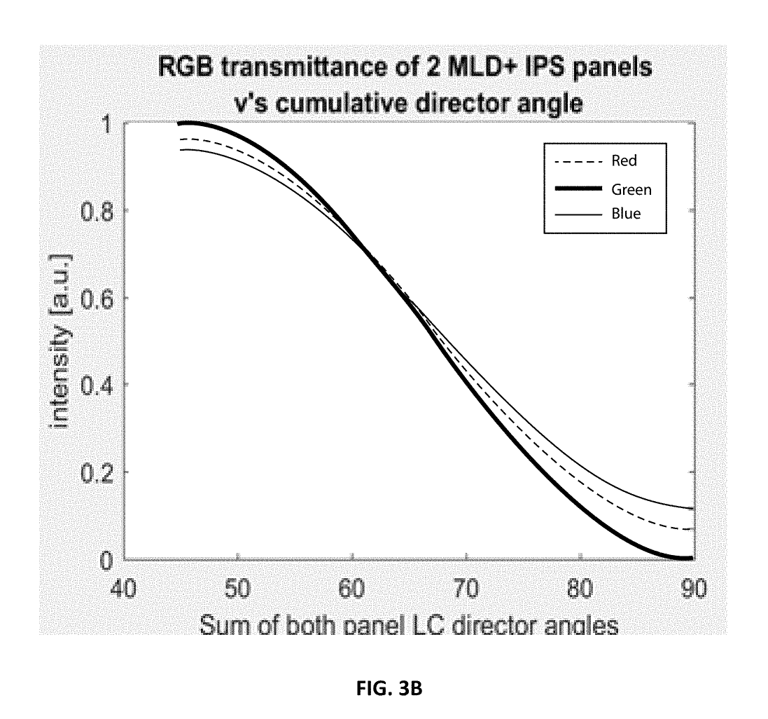

FIGS. 3A and 3B illustrate basic model RGB transmittance vs cumulative director angle of two overlaid display panels calculated using the above transmission T equation. The RGB transmittance can be determined using Jones matrix calculations or the transmission T equation discussed above. In overlaid display panels, light from a light source travels via each of the displays and can be modified or blocked by each of the panels. The polarization state can be modified by each of the panels and then subsequently absorbed by polarisers depending on state. The specific color of each panel controlled by the director angle of the respective panel will determine color and intensity displayed due to the combination of multiple panels.

FIG. 3A illustrated the RGB curves for one panel being controlled to display gray levels and the other panel being controlled to be off (θ=0°). FIG. 3B illustrated the RGB curves for one panel being controlled to display gray levels and the other panel being controlled to be on (θ=45°). The graph in FIG. 3B demonstrates that when the two display panels are overlaying with color on color, the intensity should decrease to almost zero (e.g., once the angel of both panels director angles reached 90 degrees). FIGS. 3A and 3B illustrate that the content displayed on each panel can significantly affect the transmittance of the MLD. In addition to the transmittance, content displayed on one panel can modify content displayed on another panel.

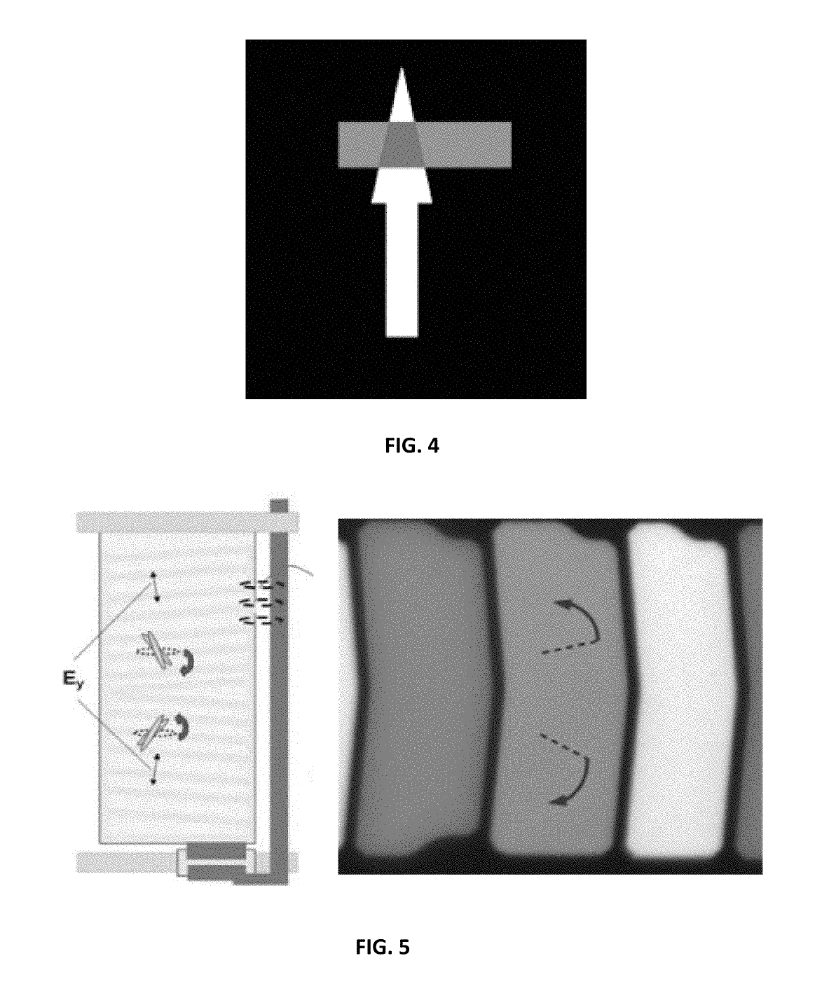

FIG. 4 illustrates an example application of the basic model on a multi-layer display system where content displayed on one panel modifies content displayed on another panel. FIG. 4 illustrates an automotive context, where a white needle of RGB (255, 255, 255) is displayed on a front layer traveling over a green rectangle of RGB (0, 255, 0) displayed on a back layer. In a region where the white needle and the green rectangle overlap, the basic model predicts a purple region to be displayed.

In practice, the actual performance of a multi-layer display varies from the basic model illustrated in FIGS. 3A, 3B, and 4. For example, when the cumulative director angle of a multi-display system approaches 90 degrees, a reduction in intensity and associated color shift is observed, but not as much as predicted in the basic model. This deviation from the basic model is used to design and display content such that the content is displayed in a relevant manner to the observers.

In some example embodiments, the deviation of the basic model is utilized with display panels having multi-domain liquid crystal display cells. In one example, the display panels are multi-domain in-plane-switching liquid crystal displays. In addition, as discussed in more detail below, displays with multi-domain cells provide an additional deviations from the basic model that is caused by liquid crystal director twist angles varying across the cell.

FIG. 5 illustrates exemplary operation of a multi-domain liquid crystal display cell. Multi-domain in-plane-switching displays are designed to provide for smaller color shift in an off axis diagonal view, faster response time, wider viewing angle, higher contrast ratio, and/or higher optical efficiently. A multi-domain liquid crystal display cell includes multiple liquid crystal director rotation directions. The multiple rotation directions are provided by different electric fields in each portion of the cell.

The electrode structure may be optimized for peak transmittance, contrast and/or good off angle color. Balance of the three domains, RH twist, LH twist and “no Twist” is significant. We have termed the third domain “no twist” and model it this way, but it is an approximation to a varying twist over the volume of the cell. This is shown in FIG. 6A. The specific electrode structure within the cell provides for the electric field in one portion of the cell to reorient the liquid crystal director in one direction, and the electric field in another portion of the cell to reorient different liquid crystal director in another direction. As illustrated in FIG. 5, the electric field causes the liquid crystal directors to be twisted into opposite directions LH and RH to provide the dual-domain liquid crystal configuration. In one example, the specific electrode structure may include chevron-shaped electrodes. The chevron-shaped electrodes may be alternatively arranged to form inter-digital electrodes on the same substrate as the common electrode and the pixel electrode. In a cell with chevron-shaped electrodes, a liquid crystal material may be disposed between a first substrate and a second substrate to form a liquid crystal cell, and a chevron shaped electrode structure including a plurality of chevron-shaped cell electrodes interleaved with a plurality of chevron-shaped common electrodes in the first substrate, wherein the interleaved plural chevron-shaped cell and common electrodes divide the cell into a plurality of regions. The plurality of regions may include a region where a director is rotated in the left hand direction LH, a region where a director is rotated in right hand direction RH (opposite to the first direction), and a region ZH, which is considered to be an ineffective portion of the cell. For IPS, FIS or FFS type displays in the literature there are only described two domains, left and right hand twist direction. Note that there are portions of the display where there is little or no twist of the LC with applied electric field. For example at the ends of each of the inter-digital electrodes the electric field direction will be parallel with the LC alignment layer so therefore will not be able to induce a twist moment to the LC in the vicinity. In a single layer LCD these inefficient regions contribute to the reduction in transmission efficiency of IPS compared to TN mode LCD. In modeling this it is efficient to lump all of these regions into a third domain models with no twist.

FIGS. 6A and 6B illustrate simulations of director distributions at different locations of a cell (source: Park, J. W.; Ahn, Y. J.; Jung, J. H.; Lee, S. H.; Lu, R.; Kim, H. Y.; Wu, S. T. Liquid crystal display using combined fringe and in-plane electric fields. Appl. Phys. Lett. 2008, 93, 081103-081105, which is incorporated by reference). FIG. 6A illustrates the twist angle and transmittance at different electrode positions A, B, C, and D, for Fringe field switching (FFS), in-plane switching (IPS), and fringe in-plane switching (FIS). This illustration is a cross sections at a midpoint in the electrode where the electric field is working efficiently to give the highest transmission. FIG. 6B illustrates simulated electric field potential and liquid crystal director distribution of FFS, IPS, and FIS, at their respective maximum transmittance voltages. Again at the ends of the electrodes the electric field lines will run out of the pages and not easily be depicted on this cross section. FIGS. 6A and 6B illustrates that for each type of LCD device, the twist angle and transmittance vary across the cell.

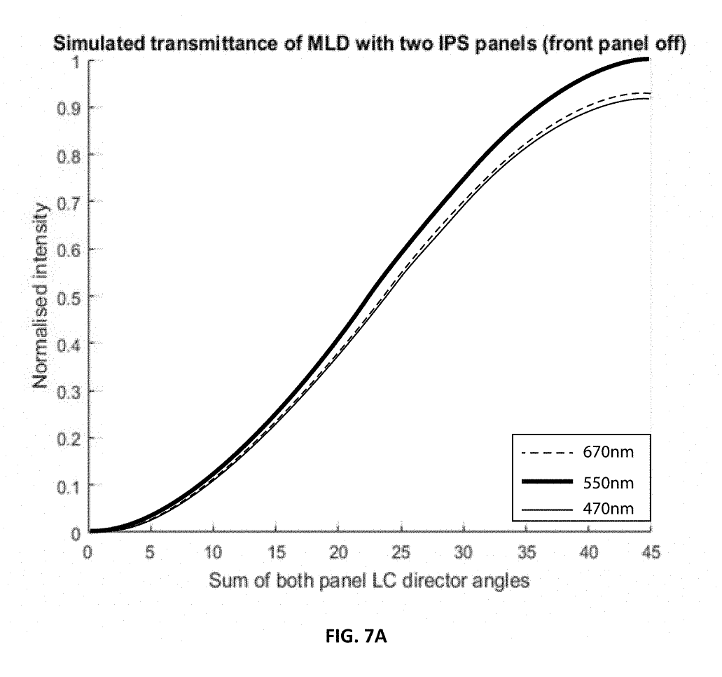

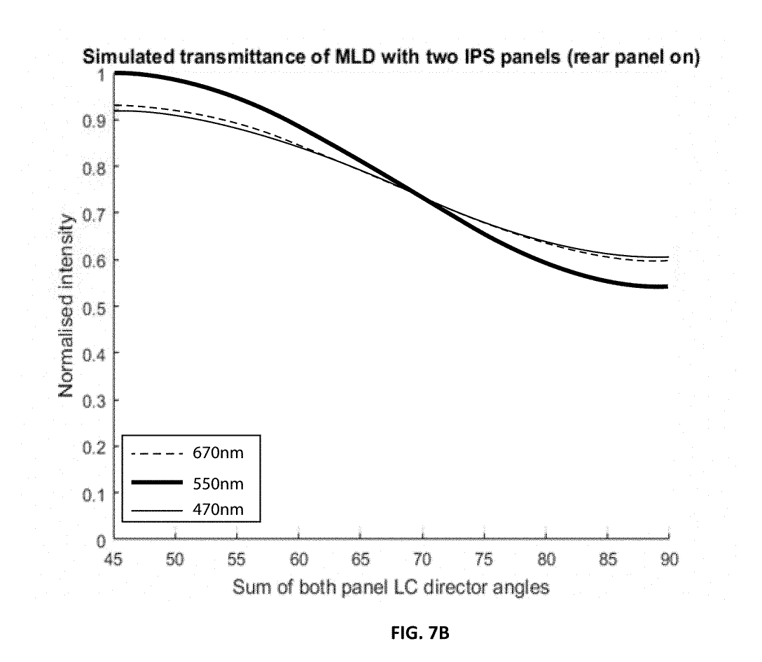

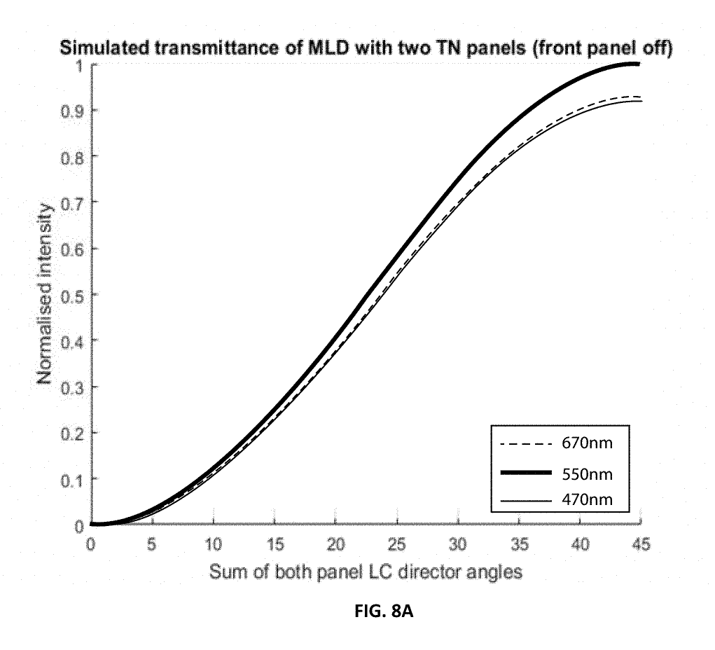

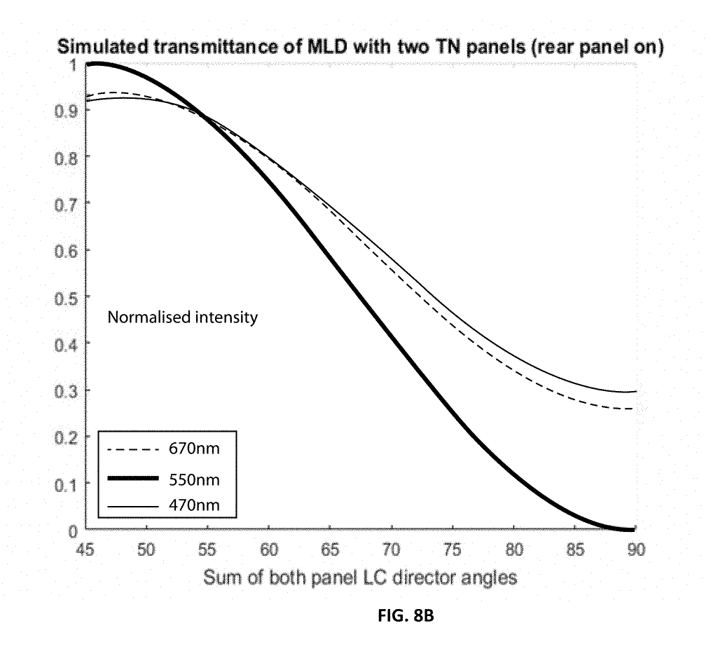

In a single layer display any given ray can pass through any one of the three domains, with rays passing through the RH and LH LC domains being able to add to the overall transmittance with the rays entering the third LC domain, ZH being blocked by the front polariser Similarly in tracing the path of any rays through two LC panels in a multilayer display one can see that there are 9 possible paths. We can label these as LH:LH, LH:RH, LH:ZH, RH:LH, RH:RH, RH:ZH, ZH:LH, ZH:RH, ZH:ZH. Each of these paths can be modelled by the transmission equation (e.g., see equation for transmission T discussed above) and transmittance graphs of FIGS. 3A and 3B. The combination results in the observed result modelled and measured in FIGS. 7A-8B for triple domain IPS.

The contribution of each of these 9 ray paths contributes to images observed in a multi-layer display to deviate from the basic model predictions and provides the ability to utilize soft additive effect for graphics displayed on the multi-layer display.

FIGS. 7A-8B illustrate simulation results of comparing triple domain IPS and single domain TN (Twisted Nematic) panels. Some implementations of IPS and its variants have single domain pixels with alternate rows being left and right hand domains. This could be useful for MLD in providing more display options beyond soft additive, such as subtractive where the top image subtracts intensity from the lower. The plots show the predicted difference between a single domain (TN) and triple domain (IPS) panel, when displaying black/white on one panel and varying the intensity on the other panel, for 3 example wavelengths (representing red, green and blue). FIG. 7A illustrates simulated transmittance of a MLD with two IPS panels, and the front panel being off. FIG. 7B illustrates simulated transmittance of a MLD with two IPS panels, and the front panel being on. FIG. 8A illustrates simulated transmittance of a MLD with two TN panels, and the front panel being off. FIG. 8B illustrates simulated transmittance of a MLD with two TN panels, and the front panel being on.

The plots were generated based on a basic model of transmission T discussed above. Modelling of apertures or color filters was not included. A value of 278 nm for the And parameter was used and, for the IPS panel, the ‘ineffective portion’ of the sub-pixel (i.e. the size of the 3rd domain) was set to 27% (in accordance with experimental observations).

As illustrated in FIGS. 7B and 8B, the normalized intensity of all three channels in the IPS MLD for the ‘white-on-white’ case is quite high (>50%) compared to the TN MLD, and that the blue and red components are stronger. This is the fundamental property of the soft additive model: the superposition of bright colors results in a brighter color than would be seen on a TN MLD model. In addition, the gamma on the individual colors set (e.g., by manufacturer) to match them at 255 (i.e. to give the expected whitepoint), further exaggerates the soft additive effect. The reason why the effect is relevant is because bright colours struggle to make even brighter colours. With TN, it's almost as if A+A=2A (resulting in really harsh blends, and colours over-rotating ruthlessly when progressing beyond white). With IPS, A+A might equal 2A when A is a weak colour (i.e. dark grey, dark in general, etc.), but when A is a brighter colour (closer to white), it has diminishing returns on increasing intensity. The effect may be called soft additive because it mirrors or substantially mirrors the classic shader model wherein stacked colours push the colour closer and closer to fully white, but struggle to actually reach this point. In classical GPU usages, this results in stacked particle effects not looking ‘washed out’ to white, while still retaining the bright spots from accumulation, whereas with MLD it ensures that stacked colours aren't treated truely additively, and that mid range colours can be added safely without fear of over-rotation.

The soft additive effect allows for overlapping objects to be simultaneously displayed on different displays of an MLD, while still providing for a realistic perception of depth due to the physical displacement of the displays. Due to the soft additive effect certain combinations of colours can be used effectively, as superpositions of these colours are more tenable. This equates to, for example, a back layer being slightly darker on average when performing blends or layering content to enable front layer content to override the former.

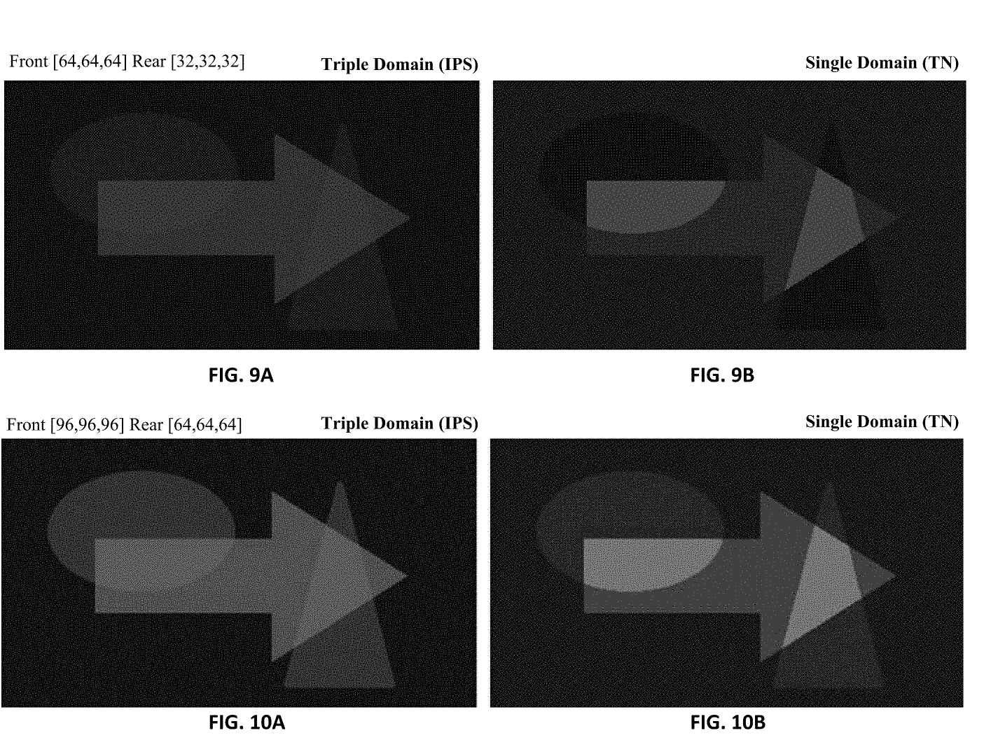

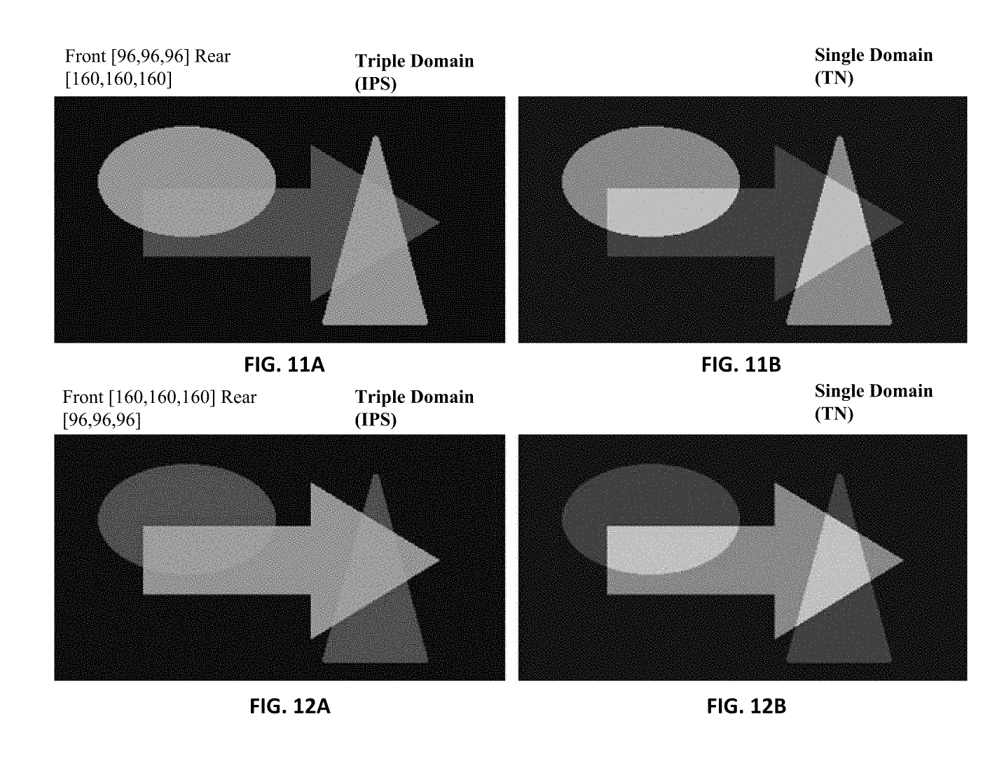

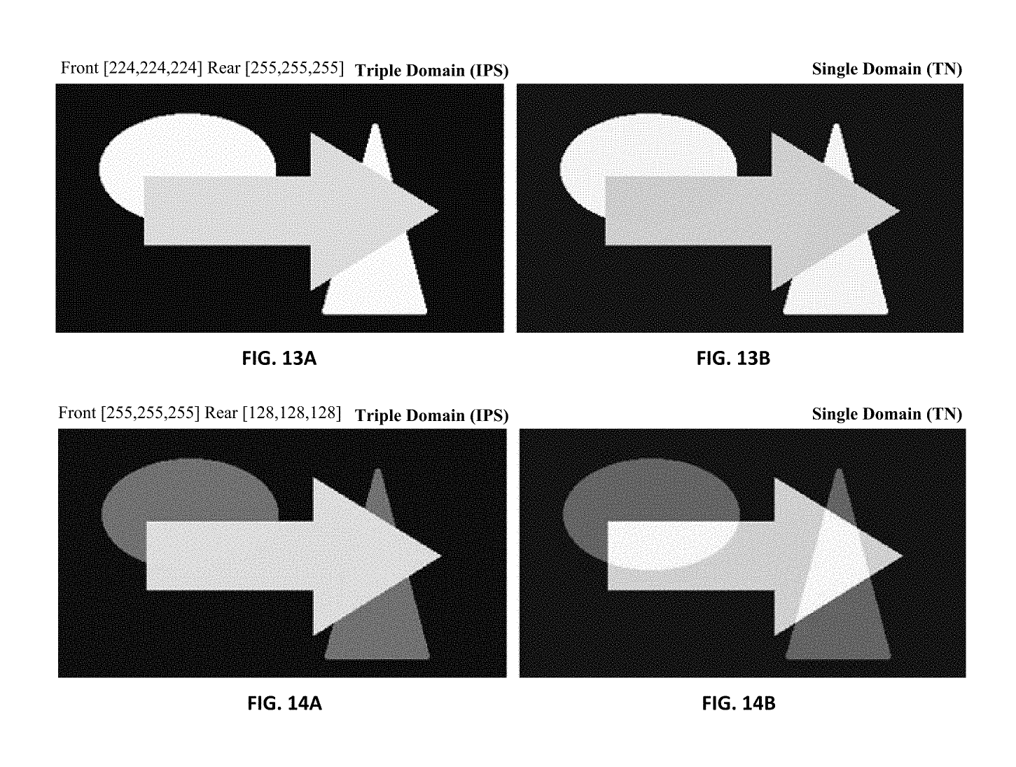

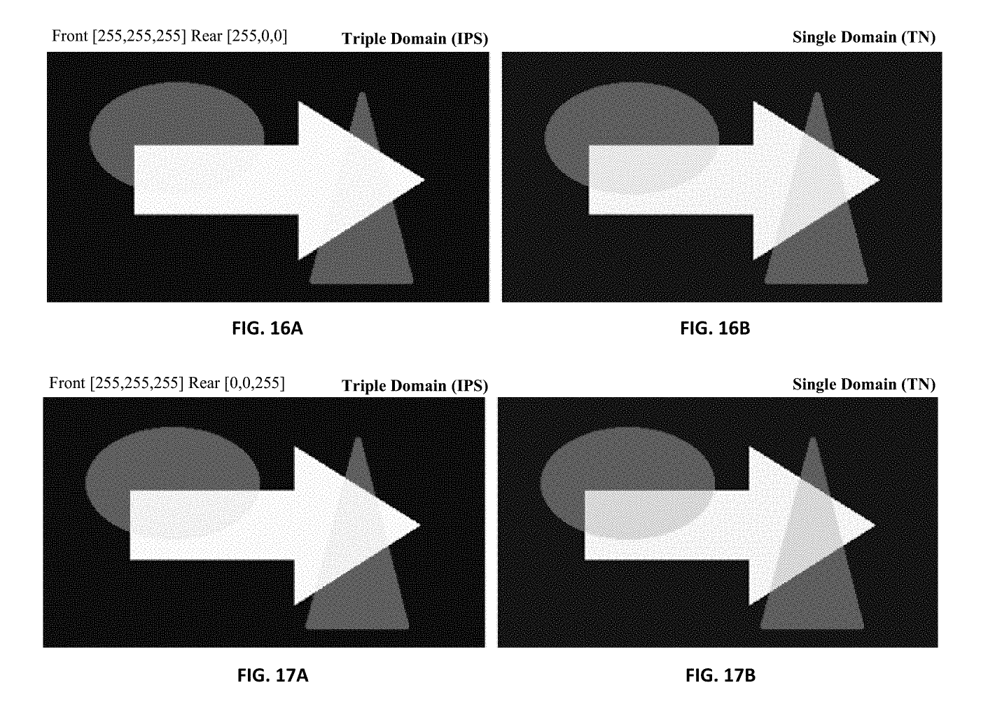

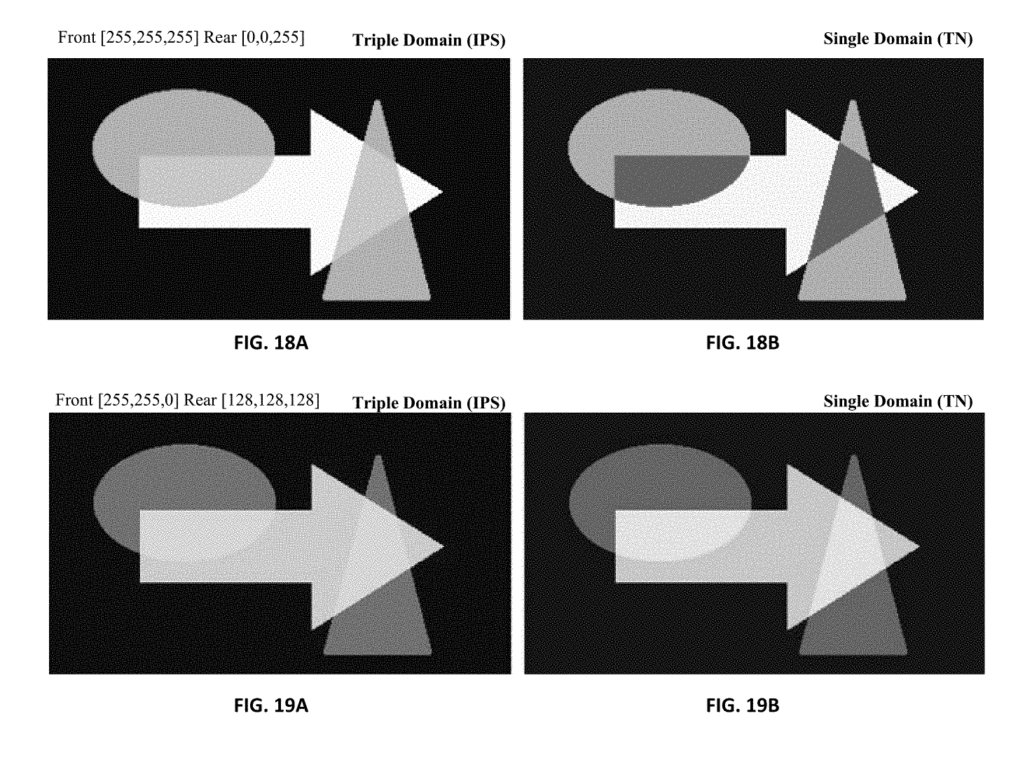

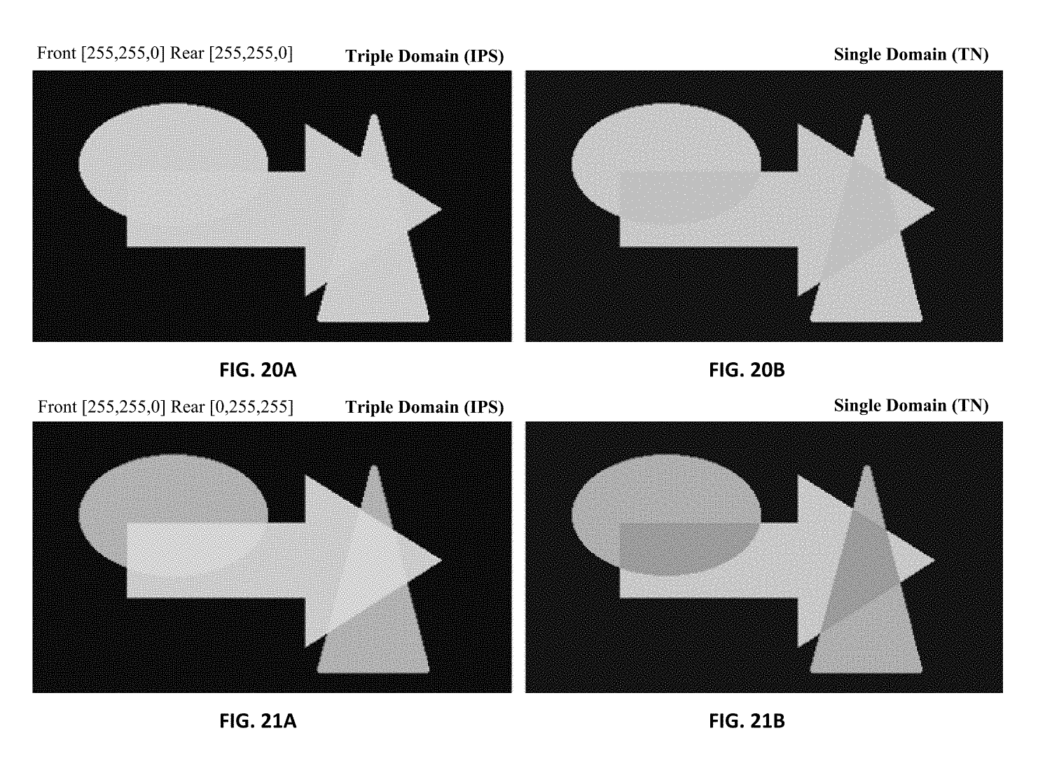

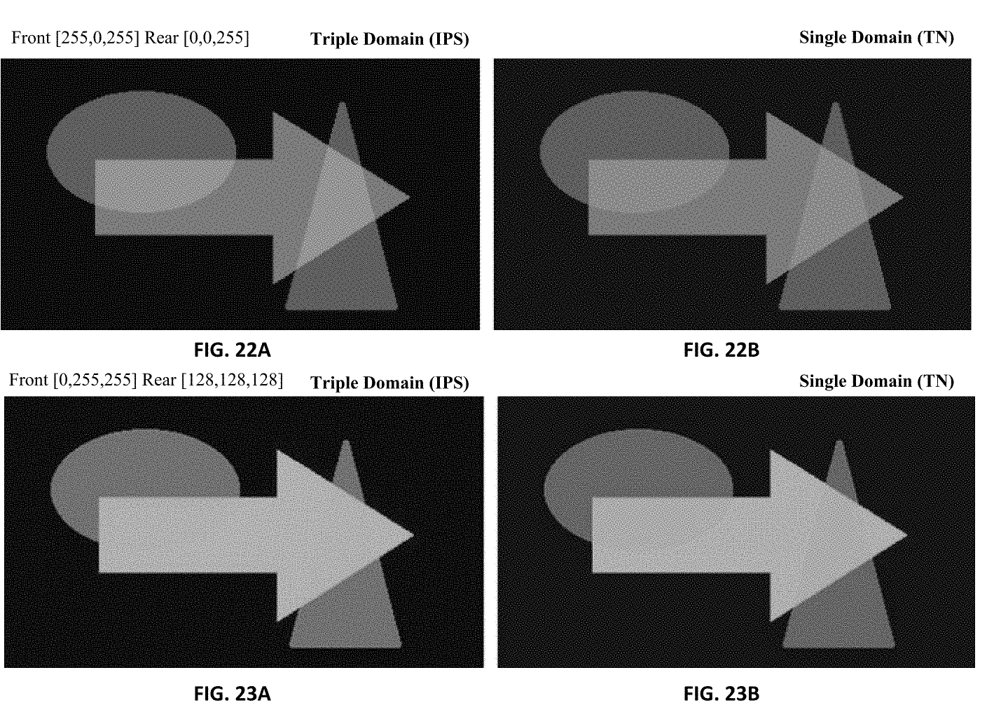

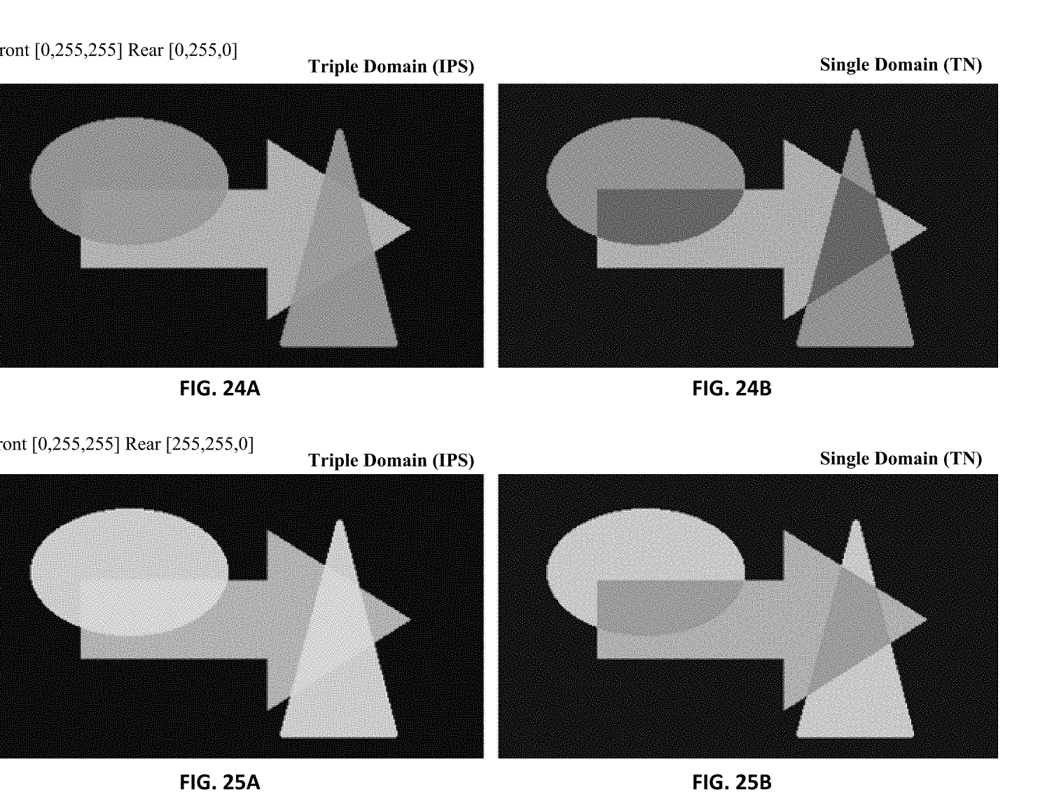

FIGS. 9A-25B illustrate simulations of MLD displays using tipple domain (IPS) model and single domain (TN) model. FIGS. 9A-15B illustrate simulations of MLD displays using gray-on-gray examples. FIGS. 16A-25B illustrate simulations of MLD displays using color-on-color examples.

For each of the images, a triangle and oval are displayed on the rear panel (in a single color/shade of gray) and an arrow is displayed on the front panel (also in a single, but generally different, color/gray). The arrow is illustrated with a portion of arrow overlapping a portion of the triangle and a portion of the oval. A portion of the arrow is displayed without overlapping the triangle or the oval.

In all simulations the 1920 JDI MLD fitted model was used with the LED BTC49 (tri-phosphor) backlight. A value of 278 nm was used for the And parameter in the model. For the triple domain (IPS) model the ‘ineffective portion’ parameter was set to 27%. The difference between the IPS and TN model is that the TN model uses a single domain only, but all other aspects of the model, e.g. apertures and color filters, were kept the same as in the IPS model.

When graphics are simultaneously displayed on different panels of a multi-layer display, it is desirable for the graphics to be superimposed in a way such that objects displayed on the front panel maintain their appearance of being solid and ‘in front’ when they overlap with objects displayed on the rear panel. The objects displayed on the front panel can maintain their appearance of being solid and ‘in front’ when they overlap with objects displayed on the rear panel, even when content is viewed slightly off-axis from the default/intended viewing angle. As illustrated in the FIGS. 9A-25B, in general triple domain (IPS) MLDs exhibit this property more often than single domain (TN) screens. This benefit provided by the triple domain (IPS) MLDs is especially observed when the foreground content is brighter than the rear content (e.g., see FIGS. 10A and 10B, FIGS. 13A and 13B, FIGS. 14A and 14B).

In view of this, exemplary embodiments of this disclosure provide for graphics to be designed in a way such that the objects displayed on the front display are brighter than the objects displayed on the rear display. Objects on a front display with a relative luminance that is higher than objects on a rear display will generally appear to be solid and ‘in front’ on the triple domain (IPS) MLDs When we run stacked colours across the front and back, the brighter the front the less ‘impact’ the back layer has. This results in the above solid and in front features. A classical additive model weights each layer equally, whereas the soft additive effect has the ability to seemingly ‘dilute’ the influence of back layers by running brighter colours on the front layer. For example, the closer to pure white the front colour is the less safe colour space there is for the back layer behind it. Over-rotation of colours still occurs (white+white→pink), but because it's more subtle it is still desirable from an optical perspective. Due to the soft additive effect a light grey+light grey→white as opposed to pink, so you there is more space to ‘add’ together to white or above without breaking into unexpected colours.

Thus graphics for display on the front display can be modified such that their relative luminance is higher than relative luminance of objects displayed on the rear display. Alternatively, graphics for display on the rear display can be modified such that their relative luminance is lower than relative luminance of objects displayed on the front display.

FIGS. 9A-25B illustrate examples where the triple domain (IPS) MLDs model provide a more realistic perception of objects displayed on displaced screens than the single domain (TN) model. While the single domain (TN) model may look better in some cases, the triple domain (IPS) MLDs model provides better results more often.

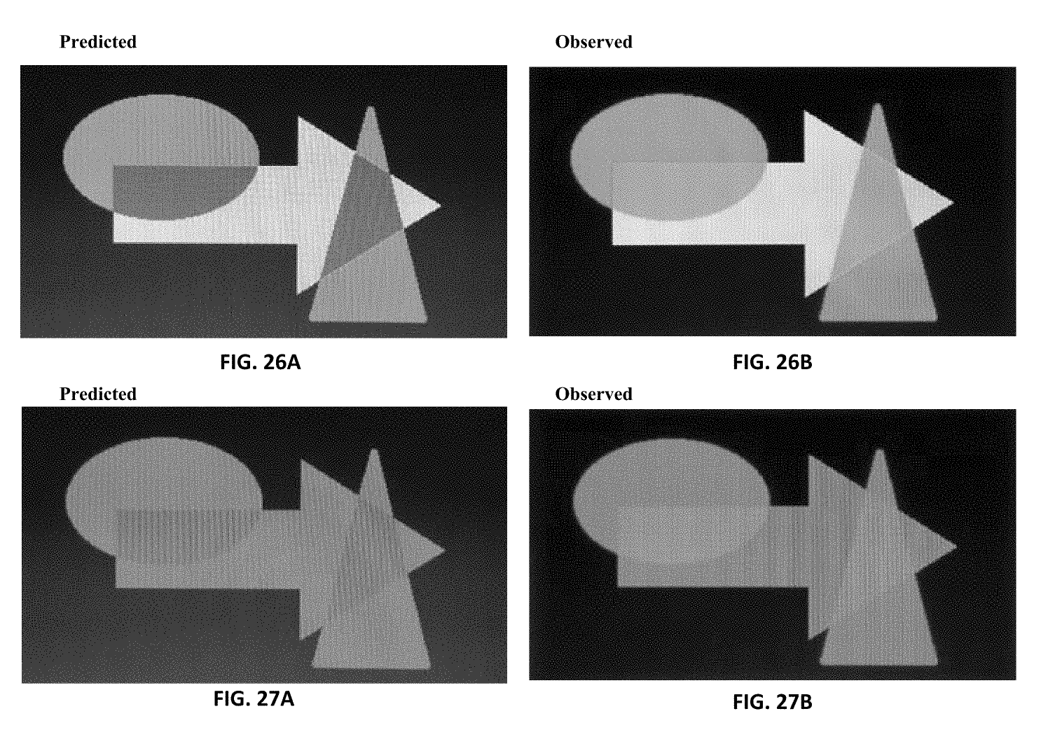

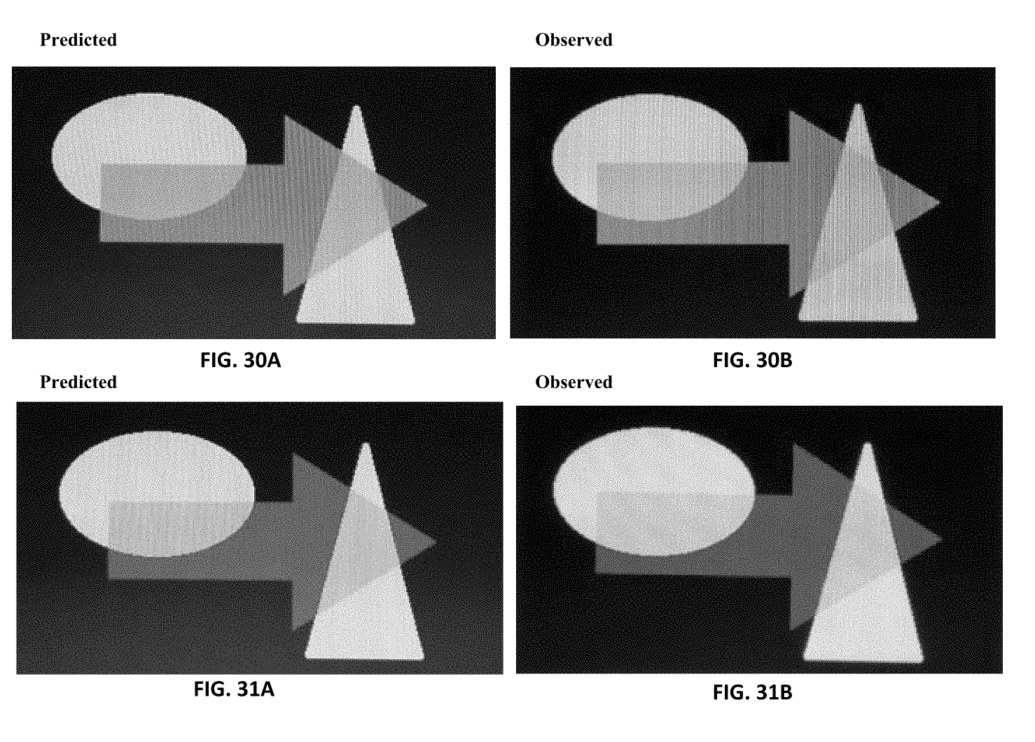

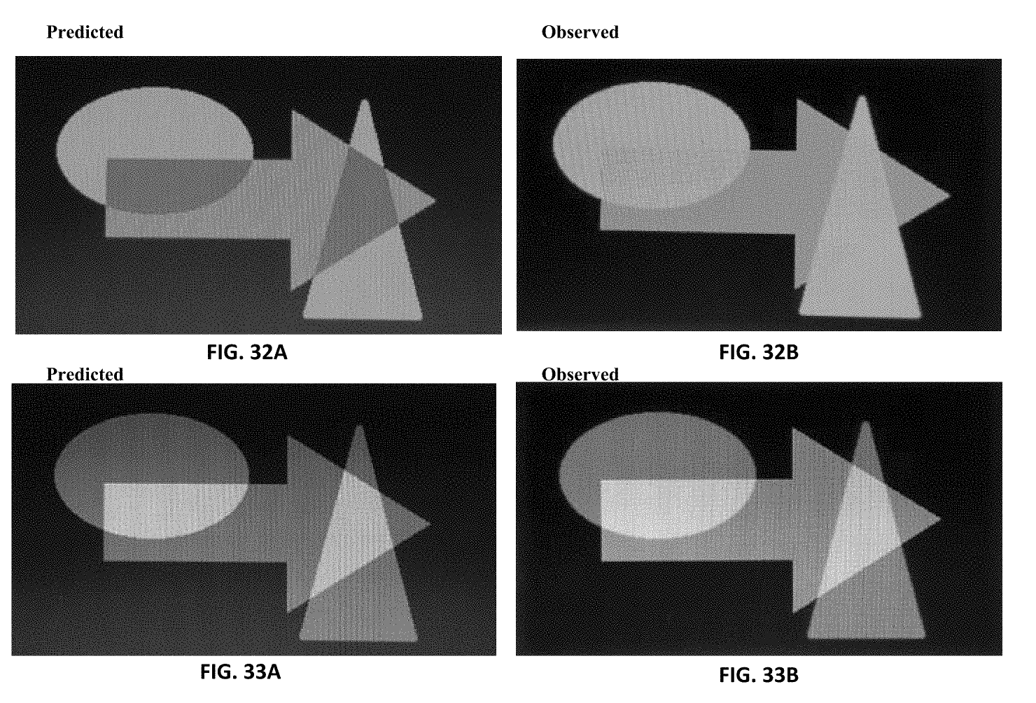

FIGS. 26A-33B illustrate validation results between simulation of a single domain (TN) model and a MLD including TN panels. The observed images are the result of displaying the front and rear panels on MLD including TN panels and then capturing an image of the MLD display with a real camera. The predicted image were obtained by displaying an image on only a front display of a MLD including TN panels and then capturing an image of the MLD display with a real camera. For the predicted image, the image displayed on the front display was generated based on the basic model. This process was performed to help reduce color reproduction discrepancies.

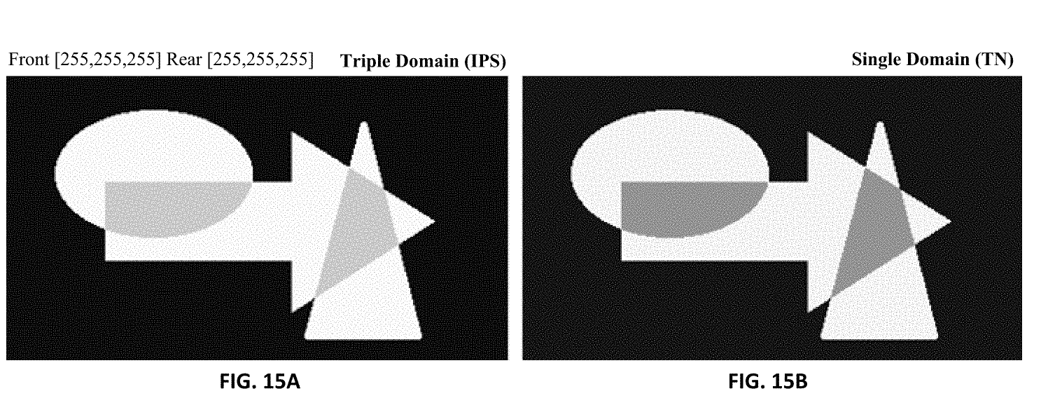

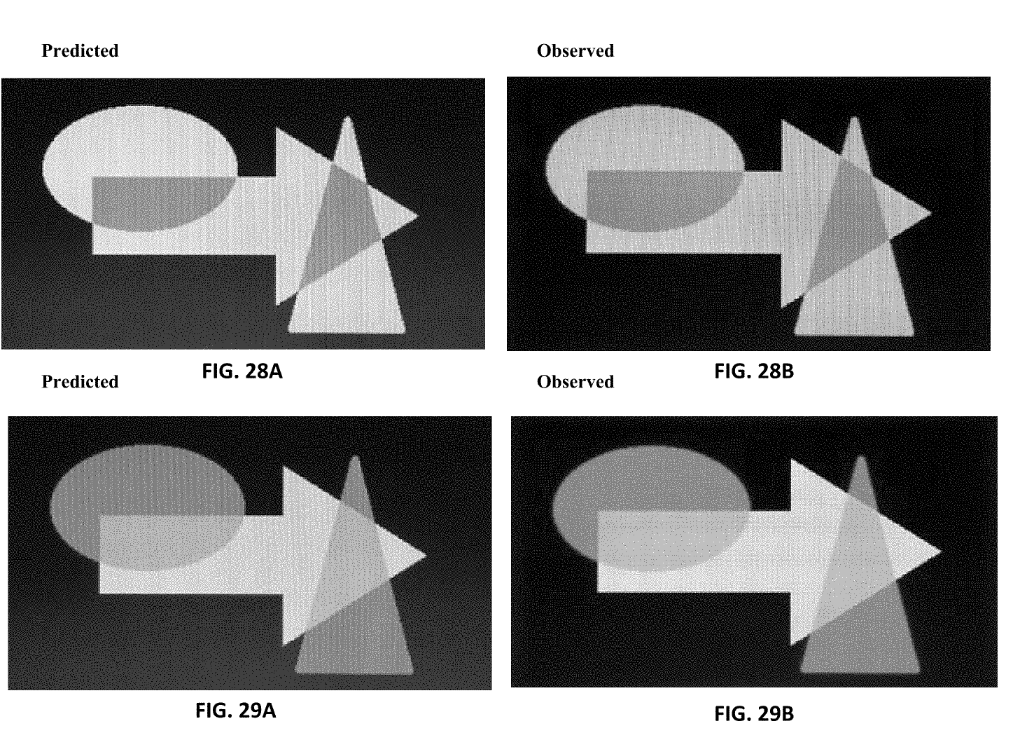

As illustrated in FIGS. 26A-33B, in most cases the predicted and observed images are reasonably similar FIGS. 26A and 26B illustrate an exception where the combination of white and cyan was observed to produce an orange color rather than the predicted dark pink. The comparison between the predicted and observed image are good given that the TN panel (a) has not been characterized/fitted, (b) is ‘unknown’ in terms of its apertures, crosstalk, color filters, etc, and (c) has a different backlight (dual phosphor) from the one used in the predictive model (tri phosphor). In particular, the prediction that white-on-white results in a dark orange color on the TN panel (versus a ‘light pink’ on IPS) is correct (see FIGS. 15B, 28A, and 28B).

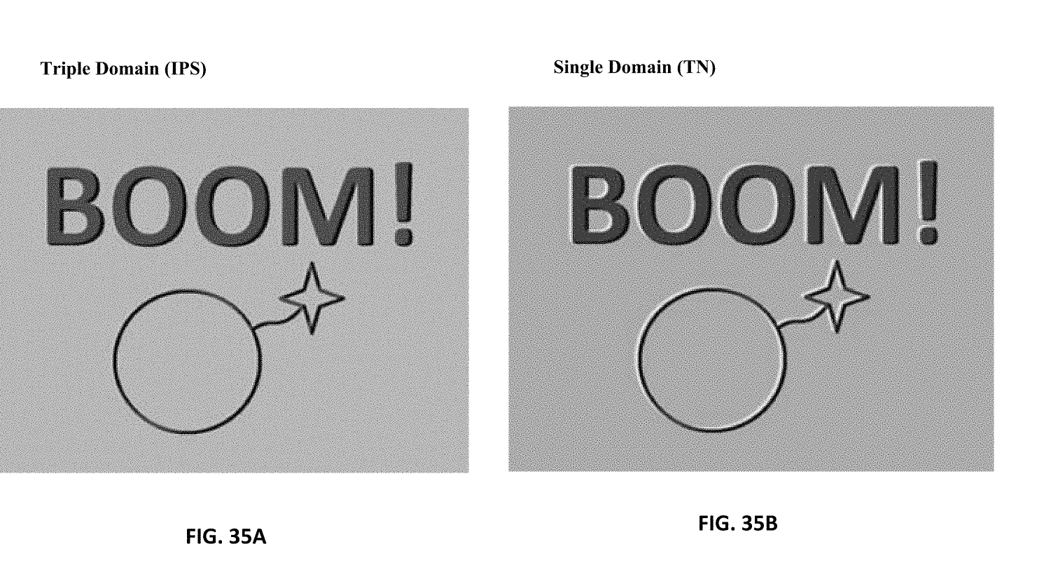

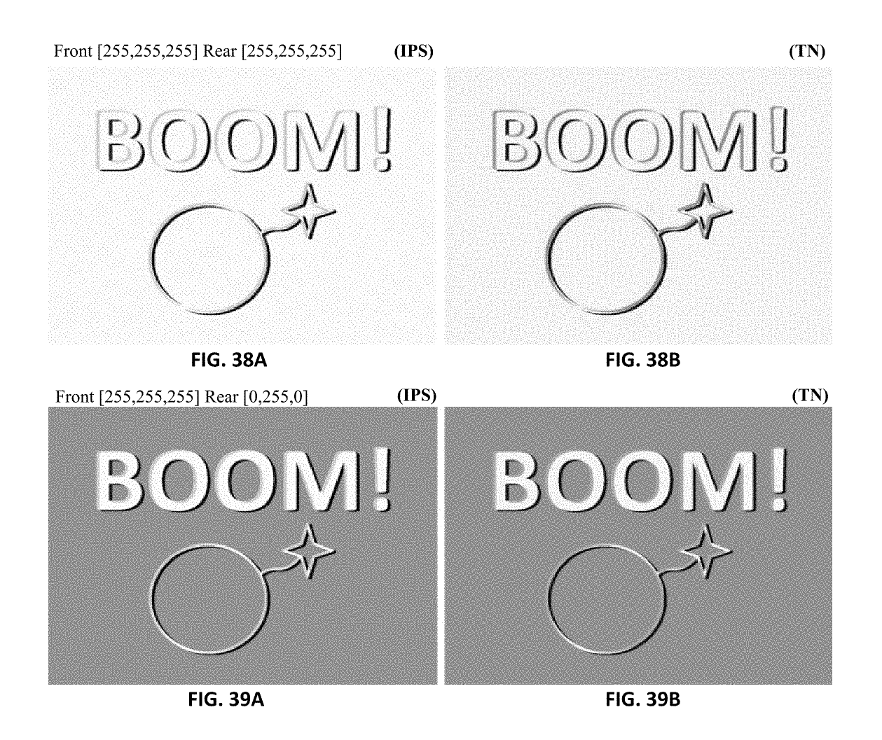

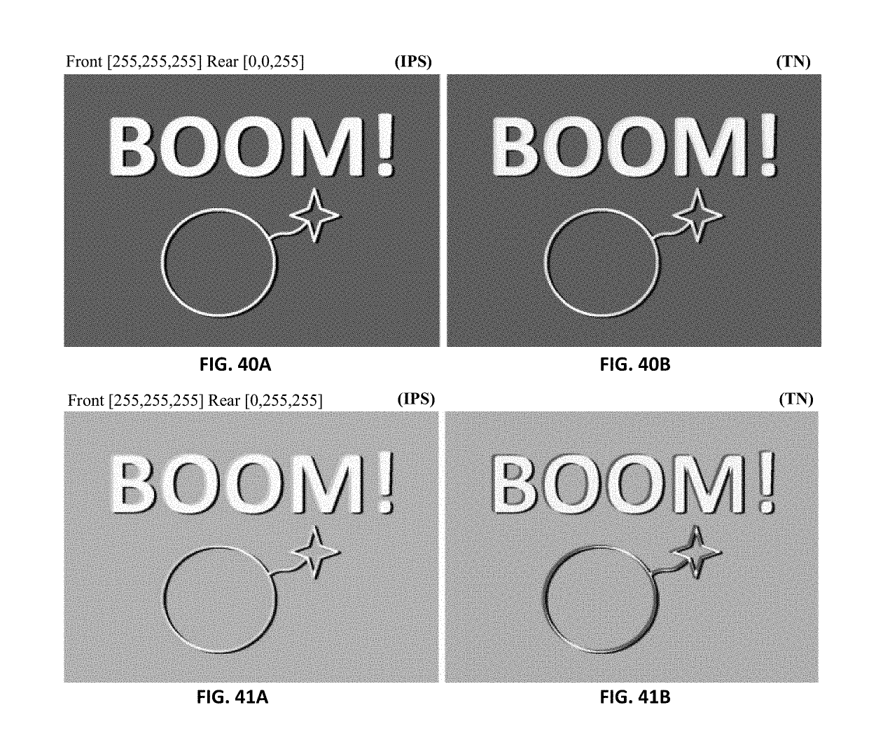

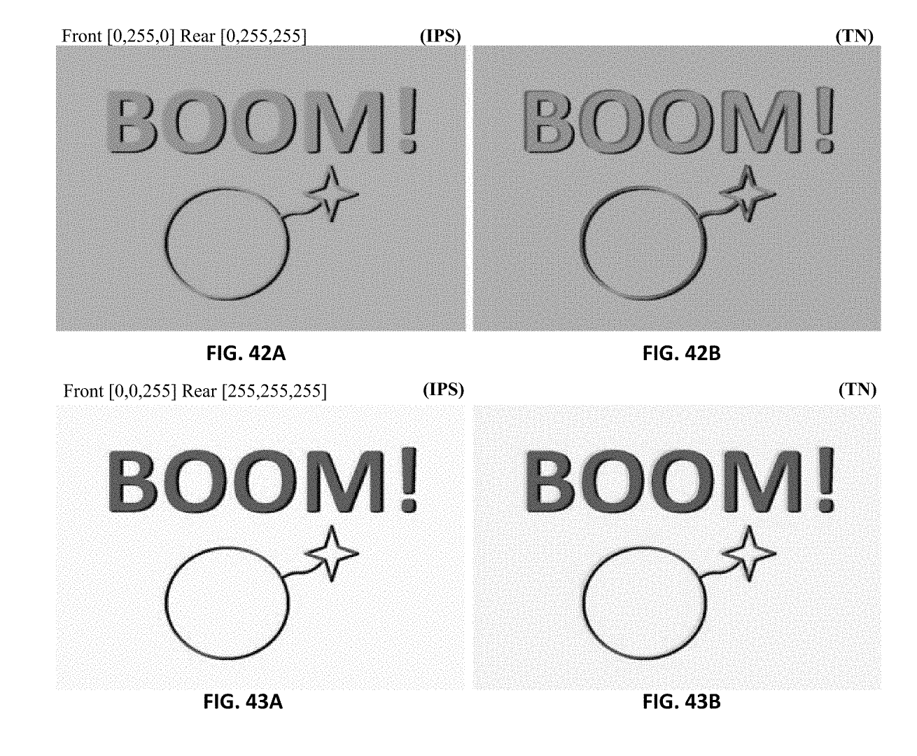

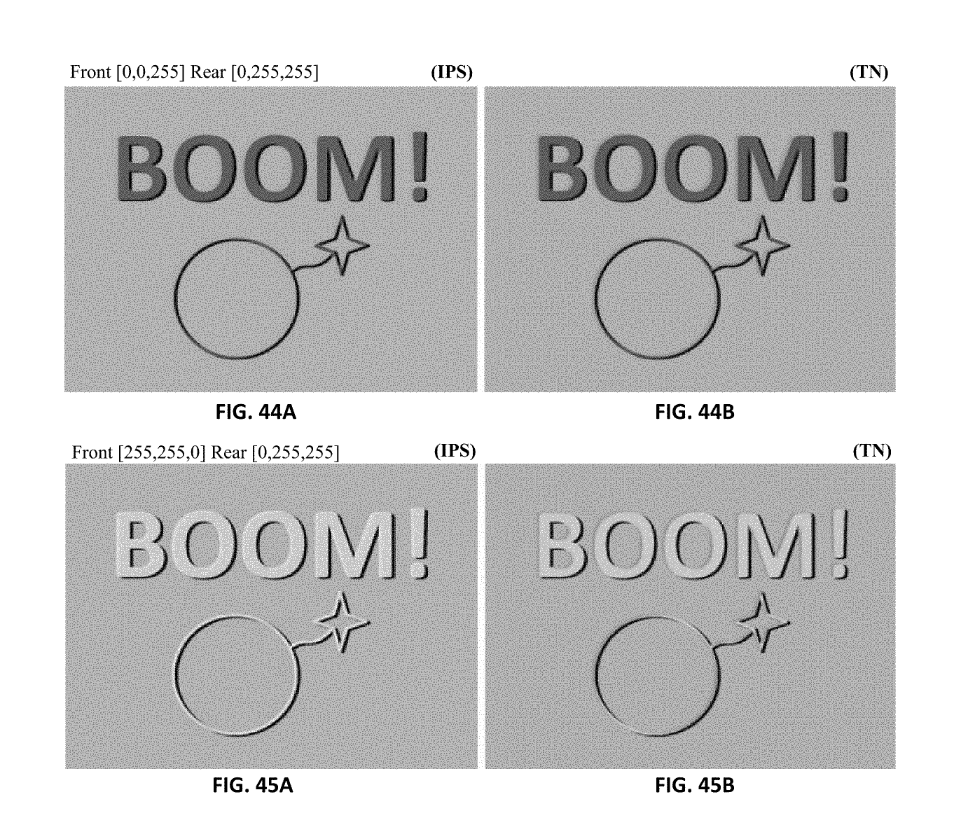

The viewing angle of the panels in a MLD is not always perpendicular to the plane of the panels, but is viewed slightly off-axis from the intended viewing angle. FIGS. 35A-45A illustrate a simulation of content displayed on a MLD (e.g., 1920 JDI) that is viewed slightly off-axis from the intended viewing angle.

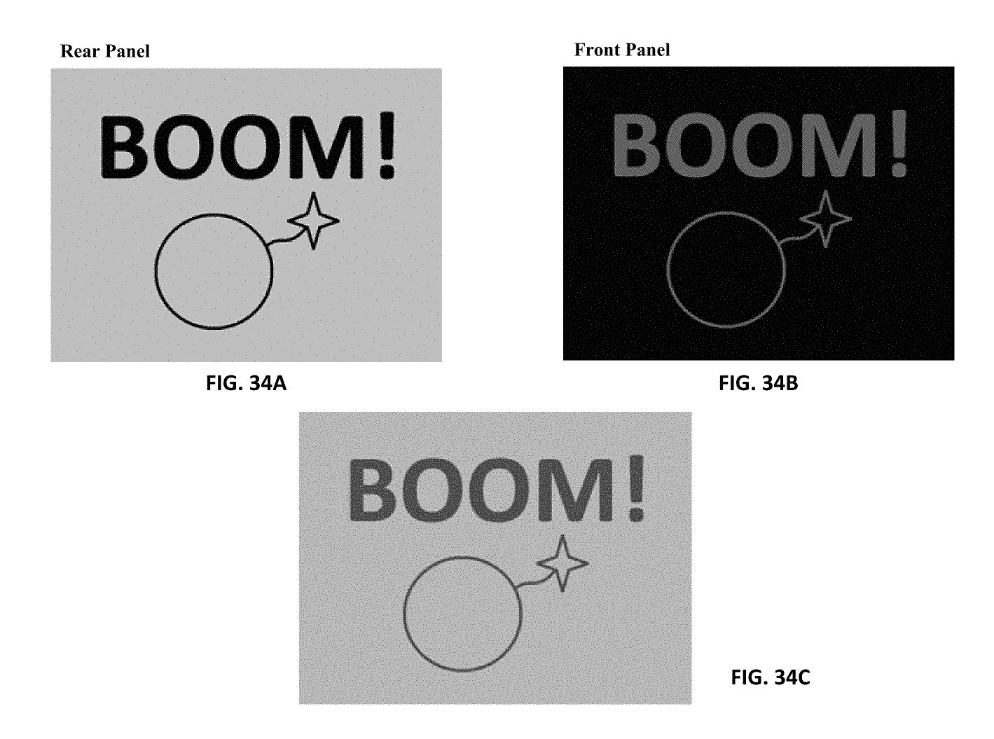

FIGS. 34A and 34B illustrate images that are displayed on rear panel and the front panel. The image for the front panel includes content (e.g., text and a graphic) which were set to a single value (gray level or RGB triple). The other portions of the image for the front panel were set to zero. The image for the rear panel includes content (e.g., text and a graphic) which were set to zero. The other portions of the image for the rear panel were set to a same value (gray level or RGB triple).

The content on the image for the rear panel corresponds to the content on the image for the front panel. The content on the image for the rear panel may have the same shape and size as the content on the image for the front panel. The content on both images may be the same and be positioned in same portions of the images such that when the images are displayed on the overlapping displayed of the MLD, the content on the front panel overlaps the content on the rear panel when viewed from the intended viewing angle.

FIG. 34A illustrates an image for a real panel with text and a graphic having a value of zero and the rest of the image having a gray level of 192. FIG. 34B illustrates an image for a front panel with text and a graphic having a gray level of 96 and the rest of the image having a gray level of zero. FIG. 34C illustrate the two images when they are superimposed and rendered using the IPS MLS model from an orthogonal viewpoint.

FIGS. 35A-35B illustrate a simulation of FIGS. 34A and 34B content displayed on a MLD and viewed slightly off-axis from the intended viewing angle for the triple domain (IPS) model and the single domain (TN) model. To simulate viewing the MLD slightly off-axis from the intended viewing angle, a horizontal and vertical displacement of a few pixels between the front and rear layers is introduced to the images. As illustrated in FIGS. 35A and 35B, when viewed slightly off-axis, the images look different from when viewed from the intended viewing angle (e.g., FIG. 34C).

In the single domain (TN) model, the superposition of grays results in a bright ‘fringe’ on the top/left side of the graphics. In the triple domain (IPS) model, this “fringe” is much less evident, due to the ‘soft additive’ effect. In both the single domain (TN) model and the triple domain (IPS) model the region of the rear panel behind the graphics is visible as a black shadow.

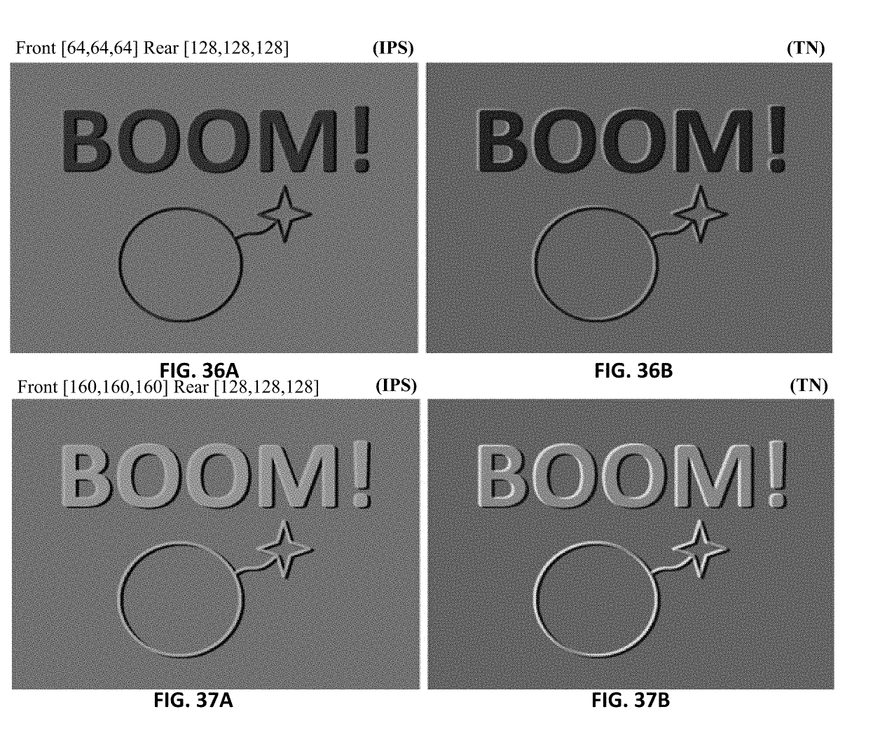

FIGS. 36A-45B illustrate simulations of content displayed on a triple domain (IPS) MLD and single domain (TN) MLD and viewed slightly off-axis from the intended viewing angle. FIGS. 36A-38B illustrate the same content (text and graphic) displayed in FIGS. 34A and 34B and offset applied to FIGS. 35A and 35B, but with different choices for the front and real panel colors. FIGS. 39A-45B illustrate the same content (text and graphic) displayed in FIGS. 34A and 34B and offset applied to FIGS. 35A and 35B, but with solid colors for the front and real panels.

As illustrated in FIGS. 36A-45B, the simulations for viewing the content slightly off-axis from the intended viewing angle in the triple domain IPS MLD, provide improved display of content as compared to the single domain TN MLD. Thus, using the triple domain IPS MLD to display content on a front display in an overlapping manner with content displayed on one or more rear displays, provides not just better results when the content is viewed in the intended viewing angle but also when the content is viewed off-axis from the intended viewing angle.

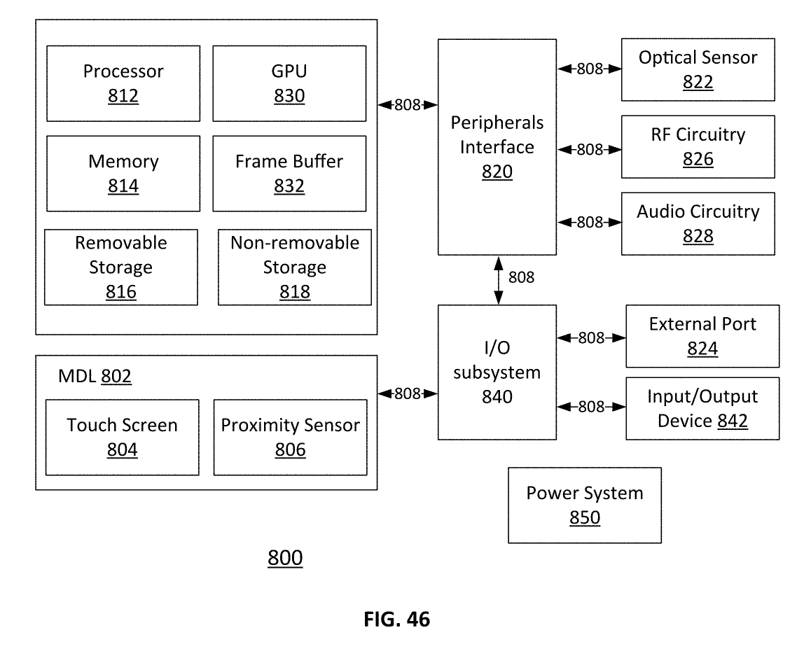

FIG. 46 illustrates an exemplary system 800 upon which embodiments of the present disclosure(s) may be implemented. The system 800 may be a portable electronic device that is commonly housed, but is not so limited. The system 800 may include a multi-layer display 802 including a plurality of overlapping displays. The multi-layer system may include a touch screen 804 and/or a proximity detector 806. The various components in the system 800 may be coupled to each other and/or to a processing system by one or more communication buses or signal lines 808.

The multi-layer display 802 may be coupled to a processing system including one or more processors 812 and memory 814. The processor 812 may comprise a central processing unit (CPU) or other type of processor. Depending on the configuration and/or type of computer system environment, the memory 814 may comprise volatile memory (e.g., RAM), non-volatile memory (e.g., ROM, flash memory, etc.), or some combination of the two. Additionally, memory 814 may be removable, non-removable, etc.

In other embodiments, the processing system may comprise additional storage (e.g., removable storage 816, non-removable storage 818, etc.). Removable storage 816 and/or non-removable storage 818 may comprise volatile memory, non-volatile memory, or any combination thereof. Additionally, removable storage 816 and/or non-removable storage 818 may comprise CD-ROM, digital versatile disks (DVD) or other optical storage, magnetic cassettes, magnetic tape, magnetic disk storage or other magnetic storage devices, or any other medium which can be used to store information for access by processing system.

As illustrated in FIG. 46, the processing system may communicate with other systems, components, or devices via peripherals interface 820. Peripherals interface 820 may communicate with an optical sensor 822, external port 824, RC circuitry 826, audio circuity 828 and/or other devices. The optical sensor 882 may be a CMOs or CCD image sensor. The RC circuity 826 may be coupled to an antenna and allow communication with other devices, computers and/or servers using wireless and/or wired networks. The system 800 may support a variety of communications protocols, including code division multiple access (CDMA), Global System for Mobile Communications (GSM), Enhanced Data GSM Environment (EDGE), Wi-Fi (such as IEEE 802.11a, IEEE 802.11b, IEEE 802.11g and/or IEEE 802.11n), BLUETOOTH (BLUETOOTH is a registered trademark of Bluetooth Sig, Inc.), Wi-MAX, a protocol for email, instant messaging, and/or a short message service (SMS), or any other suitable communication protocol, including communication protocols not yet developed as of the filing date of this document. In an exemplary embodiment, the system 800 may be, at least in part, a mobile phone (e.g., a cellular telephone) or a tablet.

A graphics processor 830 may perform graphics/image processing operations on data stored in a frame buffer 832 or another memory of the processing system. Data stored in frame buffer 832 may be accessed, processed, and/or modified by components (e.g., graphics processor 830, processor 712, etc.) of the processing system and/or components of other systems/devices. Additionally, the data may be accessed (e.g., by graphics processor 830) and displayed on an output device coupled to the processing system. Accordingly, memory 814, removable 816, non-removable storage 818, frame buffer 832, or a combination thereof, may comprise instructions that when executed on a processor (e.g., 812, 830, etc.) implement a method of processing data (e.g., stored in frame buffer 832) for improved display quality on a display.

The memory 814 may include one or more applications. Examples of applications that may be stored in memory 814 include, navigation applications, telephone applications, email applications, text messaging or instant messaging applications, memo pad applications, address books or contact lists, calendars, picture taking and management applications, and music playing and management applications. The applications may include a web browser for rendering pages written in the Hypertext Markup Language (HTML), Wireless Markup Language (WML), or other languages suitable for composing webpages or other online content. The applications may include a program for browsing files stored in memory.

The memory 814 may include a contact point module (or a set of instructions), a closest link module (or a set of instructions), and a link information module (or a set of instructions). The contact point module may determine the centroid or some other reference point in a contact area formed by contact on the touch screen. The closest link module may determine a link that satisfies one or more predefined criteria with respect to a point in a contact area as determined by the contact point module. The link information module may retrieve and display information associated with selected content.

Each of the above identified modules and applications may correspond to a set of instructions for performing one or more functions described above. These modules (i.e., sets of instructions) need not be implemented as separate software programs, procedures or modules. The various modules and sub-modules may be rearranged and/or combined. Memory 814 may include additional modules and/or sub-modules, or fewer modules and/or sub-modules. Memory 814, therefore, may include a subset or a superset of the above identified modules and/or sub-modules. Various functions of the system may be implemented in hardware and/or in software, including in one or more signal processing and/or application specific integrated circuits.

Memory 814 may store an operating system, such as Darwin, RTXC, LINUX, UNIX, OS X, WINDOWS, or an embedded operating system such as VxWorks. The operating system may include procedures (or sets of instructions) for handling basic system services and for performing hardware dependent tasks. Memory 814 may also store communication procedures (or sets of instructions) in a communication module. The communication procedures may be used for communicating with one or more additional devices, one or more computers and/or one or more servers. The memory 814 may include a display module (or a set of instructions), a contact/motion module (or a set of instructions) to determine one or more points of contact and/or their movement, and a graphics module (or a set of instructions). The graphics module may support widgets, that is, modules or applications with embedded graphics. The widgets may be implemented using JavaScript, HTML, Adobe Flash, or other suitable computer program languages and technologies.

An I/O subsystem 840 may include a touch screen controller, a proximity controller and/or other input/output controller(s). The touch-screen controller may be coupled to a touch-sensitive screen or touch sensitive display system. The touch screen and touch screen controller may detect contact and any movement or break thereof using any of a plurality of touch sensitivity technologies now known or later developed, including but not limited to capacitive, resistive, infrared, and surface acoustic wave technologies, as well as other proximity sensor arrays or other elements for determining one or more points of contact with the touch-sensitive screen. A touch-sensitive display in some embodiments of the display system may be analogous to the multi-touch sensitive screens.

The other input/output controller(s) may be coupled to other input/control devices 842, such as one or more buttons. In some alternative embodiments, input controller(s) may be coupled to any (or none) of the following: a keyboard, infrared port, USB port, and/or a pointer device such as a mouse. The one or more buttons (not shown) may include an up/down button for volume control of the speaker and/or the microphone. The one or more buttons (not shown) may include a push button. The user may be able to customize a functionality of one or more of the buttons. The touch screen may be used to implement virtual or soft buttons and/or one or more keyboards.

In some embodiments, the system 800 may include circuitry for supporting a location determining capability, such as that provided by the Global Positioning System (GPS). The system 800 may include a power system 850 for powering the various components. The power system 850 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices. The system 800 may also include one or more external ports 824 for connecting the system 800 to other devices.

Portions of the present invention may be comprised of computer-readable and computer-executable instructions that reside, for example, in a processing system and which may be used as a part of a general purpose computer network (not shown). It is appreciated that processing system is merely exemplary. As such, the embodiment in this application can operate within a number of different systems including, but not limited to, general-purpose computer systems, embedded computer systems, laptop computer systems, hand-held computer systems, portable computer systems, stand-alone computer systems, game consoles, gaming systems or machines (e.g., found in a casino or other gaming establishment), or online gaming systems.

1. An instrument panel comprising;
a multi-layer display system including a front display panel and a rear display panel arranged in a substantially parallel manner, the front display panel overlapping the rear display panel, the front display panel and the rear display panel each including a plurality of multi-domain liquid crystal display cells;
a backlight configured to provide light to the front display panel and the rear display panel of the multi-layer display system; and
a processing system comprising at least one processor and memory, the processing system configured to:
display a first object on the front display panel; and
display, on the rear display panel, a second object such that the second object is at least partially overlapped by the first object.

2. The instrument panel of claim 1, wherein the front display panel and the rear display panel are multi-domain in-plane-switching liquid crystal displays.

3. The instrument panel of claim 1, wherein the front display panel and the rear display panel are triple-domain in-plane-switching liquid crystal displays.

4. The instrument panel of claim 1, wherein the first object is displayed such that at least a portion of the first object overlaps the second object displayed on the rear display panel, and at least a portion of the first object is displayed without overlapping the second object.

5. The instrument panel of claim 1, wherein relative luminance of the first object displayed on the front display panel is higher than relative luminance of the second object displayed on the rear display panel.

6. The instrument panel of claim 1, wherein the first object is of a uniform color that is different from a uniform color of the second object.

7. The instrument panel of claim 6, wherein the first object is displayed in a manner to maintain appearance of being solid and in front of the second object displayed on the rear display panel.

8. The instrument panel of claim 6, wherein the first object is displayed in a manner on the front display panel to maintain appearance of being solid and in front of the second object displayed on the rear display panel.

9. The instrument panel of claim 1, wherein the first object has a same shape and size as the second object, and the first and second objects are displayed in an overlapping manner

10. The instrument panel of claim 1, wherein the first object has a same shape and size as the second object, and the first and second objects are displayed in an overlapping manner

11. The instrument panel of claim 1, wherein the front display panel is a touch sensitive display, and the processing system is configured to detect whether a touch input is performed to a portion of the front display panel displaying the first object.

12. The instrument panel of claim 1, wherein the plurality of multi-domain liquid crystal display cells in the front display panel and rear display include a liquid crystal material disposed between a first substrate and a second substrate to form a liquid crystal cell, and a chevron shaped electrode structure including a plurality of chevron-shaped cell electrodes interleaved with a plurality of chevron-shaped common electrodes in the first substrate, wherein the interleaved plural chevron-shaped cell and common electrodes divide liquid crystal cell into a plurality of regions.

13. A multi-layer display system, comprising:
a first display and a second display arranged in a substantially parallel manner to the first display, the first display overlapping the second display, and the first display and the second display each including a plurality of multi-domain liquid crystal display cells;
a light source configured to provide light to the first display and the second display; and
a processing system comprising at least one processor and memory, the processing system configured to:
display a first object on the first display; and
display, on the second display, a second object such that the second object is at least partially overlapped by the first object.

14. The multi-layer display system of claim 13, wherein the first display and the second display are multi-domain in-plane-switching liquid crystal displays.

15. The multi-layer display system of claim 13, wherein the first and second displays are triple-domain in-plane-switching liquid crystal displays.

16. The multi-layer display system of claim 13, wherein the first object is displayed such that at least a portion of the first object overlaps the second object displayed on the second display, and at least a portion of the first object is displayed without overlapping the second object.

17. The multi-layer display system of claim 13, wherein relative luminance of the first object displayed on the first display is higher than relative luminance of the second object displayed on the second display.

18. The multi-layer display system of claim 13, wherein the first object if of a uniform color that is different from a uniform color of the second object.

19. The multi-layer display system of claim 13, wherein the first object has a same shape and size as the second object, and the first and second objects are displayed in an overlapping manner

20. The multi-layer display system of claim 13, wherein the first display is a touch sensitive display, and the processing system is configured to detect whether a touch input is performed to a portion of the front display displaying the first object.

21. The multi-layer display system of claim 13, wherein relative luminance of the first object displayed on the first display is higher than relative luminance of the second object displayed on the second display.

22. The multi-layer display system of claim 13, wherein the processing system is further configured to: in response to instructions to move the second object displayed on the second display to the first display, display the second object with a relative luminance that is higher than the relative luminance used to display the second object on the first display.

23. The multi-layer display system of claim 22, wherein the second object displayed on the first display at least partially overlaps content displayed on the first display.
